(19) United States
(12) Patent Application Publication
(10) Pub. No.: US 2023/0141815 A1
(43) Pub. Date: May 11, 2023

(54) METHOD FOR MAKING FLAKES

(71) Applicant: LANDA LABS (2012) LTD, Rehovot (IL)

(72) Inventors: Benzion LANDA, Nes Ziona (IL); Guy FEFFERMAN, Givatayim (IL); Tamar ASHER, Kiryat Ono (IL); Vadim YAKHEL, Kiryat Gat (IL); Yosef SHACHAK, Kfar Saba (IL); Viacheslav RABINOVICH, Ashkelon (IL); Aleksey Elisha LEVIN, Bnei Reem (IL)

(73) Assignee: LANDA LABS (2012) LTD, Rehovot (IL)

(21) Appl. No.: 17/907,560

(22) PCT Filed: Apr. 1, 2021
(86) PCT No.: PCT/IB2021/052743

§ 371 Date: Sep. 28, 2022

(30) Foreign Application Priority Data
Apr. 2, 2020 (GB) 2004904.5

(51) Int. Cl. B22F 1/068; B22F 1/05; B22F 1/054; B22F 9/04

(52) U.S. Cl. CPC B22F 1/068; B22F 1/05; B22F 1/0551; B22F 9/04; B22F 2301/052

(57) ABSTRACT

A method is disclosed for producing flakes of a first material, the method comprising: a) supporting two supply cylinders of the first material and a fatiguing rod assembly, that includes at least one textured fatiguing rod, so that each fatiguing rod is sandwiched between the two cylinders, each fatiguing rod having a diameter smaller than an initial diameter of the two supply cylinders and being made of a second harder material; b) urging the surfaces of the two supply cylinders into contact with each fatiguing rod; and c) causing the supply cylinders and the fatiguing rod(s) to rotate while making rolling line contact with one another; wherein the supply cylinders and each fatiguing rod are urged against one another with sufficiently high contact pressure to modify the surface of the supply cylinders by fatigue and result in separation of flakes from the surfaces of the cylinders.

### CROSS-REFERENCE TO RELATED APPLICATIONS

The present application is a National Phase Application filed under 35 U.S.C. 371 as a national stage of International Application No. PCT/IB2021/052743, filed on Apr. 1, 2021, which claims Paris Convention priority from, GB 2004804.5, filed on 2 Apr. 2020. This application is also related to International Application No. PCT/IB2021/052742 titled “Apparatus for Making Flakes”. The entire contents of the afore-mentioned applications are incorporated herein by reference for all purposes as if fully set forth herein. Any matter disclosed in GB 2004804.5, published as GB 2593768, but not contained in the present application is not disclaimed and the Applicant reserves the right to import matter disclosed therein into the present application.

### FIELD

The present disclosure relates to production of flakes, such as metal, ceramic, plastics or glass flakes.

### BACKGROUND

Particles having lamellar shapes are characterized by their aspect ratio, i.e. the ratio of a representative planar dimension to the transverse dimension, the greater the aspect ratio, the thinner the flake. The term “flake” is used herein to refer to a thin planar particle having an aspect ratio no less than 3:1 but usually significantly greater, for example between 10:1 and 100:1. Flakes are preferred in various fields, for example, metal flakes may be used in diverse industries such as painting, printing, coating, electrochemical electrodes, reflectors, fuel cell hydrogen storage devices, explosives, solar cells, and cosmetics. Aluminium flakes account for about 40% of the metal flakes that are currently produced, copper flakes forming about 24%, and zinc or stainless steel flakes each forming about 14% of this market, in which nickel flakes contribute approximately 8%. Because of the high demand for metal flakes, their production is a primary, though not sole, aim of the invention.

Metal flakes are conventionally made by hammering, ball milling, or physical vapour deposition (PVD). In the hammering method, a metal sheet is thinned by hammering and then reduced into flakes. Ball milling may be wet or dry and conducted at low or high speed. Examples of ball milling methods include attritor, vibratory, horizontal, and planetary ball milling. In any ball milling method, grinding media in the form of balls randomly collide with large metal particles that start as spheres or with a low aspect ratio. Due to the compression and shear forces that are exerted on the relatively large particles, they are progressively flattened into flakes. In physical vapor deposition, metal is vaporized and then deposited on a carrier. Once the metal has condensed into a film on the carrier, various techniques may be used to remove the film from the carrier in flake form.

Metal flakes prepared by hammering or ball milling tend to be relatively thick. Typically, they may have a thickness in the micron range (e.g., between 1 micrometer (μm) and 100 μm), with higher end products having a thickness in the sub-micron range (e.g., between 25 nanometer (nm) and 1 μm). By contrast, metal flakes prepared by PVD may be thinner, with a thickness in the range of 20 nm to 100 nm, flakes with a thickness in the range of 30 nm to 50 nm being generally preferred for visual effect in particularly demanding industries. Typically, the topography of the planar surfaces of PVD-prepared flakes is more regular than the topography of the planar surface of flakes prepared by ball milling. Therefore, PVD-prepared flakes are generally shinier than their non-PVD made counterparts, enabling the product in which they are used to display a higher gloss.

While PVD-prepared flakes are preferred for a number of industrial applications, their manufacturing method is more expensive, rendering their cost prohibitive for many products.

### Object

The invention seeks therefore to provide inter alia a cost-effective method of producing flakes.

### SUMMARY

According to a first aspect of the invention, there is provided a method of producing flakes, which comprises:
a. supporting two supply cylinders and a fatiguing rod assembly, that includes at least one fatiguing rod, in such a manner that each fatiguing rod is sandwiched between the two supply cylinders made of a first material from which flakes are to be produced, each fatiguing rod having a diameter smaller than an initial diameter of the two supply cylinders and being made of a second material harder than the first material;
b. urging the surfaces of the two supply cylinders into contact with each fatiguing rod; and
c. causing the supply cylinders and the fatiguing rods to rotate while making rolling line contact with one another;
   wherein at least one fatiguing rod of the fatiguing rod assembly is textured; and wherein the supply cylinders and each fatiguing rod are urged against one another with sufficiently high contact pressure to modify the surface of the supply cylinders by fatigue and result in separation of flakes of the first material from the surfaces of the supply cylinders.

In some embodiments, a fluid is applied to each fatiguing rod and supply cylinder during rotation thereof, the fluid being inter alia operative to carry away flakes produced by the fatiguing of the supply cylinders. In such embodiments, the method further comprises collecting the produced flakes and optionally the fluid which carries them. The fluid can be a liquid or a gas.

To the extent the produced flakes are collected with part of the fluid, the method may further comprise separating at least a proportion of the flakes from the fluid. The separation can eliminate the fluid (e.g., by drying) or isolate the flakes (or a proportion thereof), or both. The separating of at least a proportion of the flakes from the fluid can be based on individual characteristics of the first material and relative affinity thereto (e.g., a magnet assisting in the separation of flakes made of a magnetic material) or rely on more universal properties (e.g., density, size, etc.) and proceed by decanting, centrifuging, or filtering.

In some embodiments, the fluid is a liquid and the method further comprises recirculating at least a part of the liquid being collected or being separated to at least part of each line of contact between each supply cylinder and a fatiguing rod.

In some embodiments, the fluid is a liquid comprising one or more additives. To the extent that the method further comprises recirculating such an additive-supplemented liquid, the method may in some embodiments further include monitoring the level of the one or more additives in the liquid, and/or adding to the liquid a fresh amount of the one or more additives, so as to maintain any desired amount thereof. Addition of additives to the liquid may for instance compensate for any amount of additive “lost” in the process, such as by coating of the produced flakes by the additives or derivatives thereof. Typically, the additives are selected to provide one or more of the following effects, depending on the material from which the flakes are to be produced: anti-caking, anti-corrosion, anti-foaming, anti-oxidant, anti-wear, or to promote friction, lubrication, traction, preservation, and any desired rheology.

In some embodiments, at least one of the one or more additives that may be present in a liquid fluid as used in the present method can modify the outer surface of the produced flakes, such that the chemical composition of the outer surface of the flakes differs from a chemical composition of a core of the flakes. Such modifications may provide for a long lasting effect of the additive regardless of its intended use, and for illustration, may provide for prolonged protection against oxidation. Additionally or alternatively, such modification may be tailored to suit a particular intended use of the flakes. For illustration, assuming that the flakes are to be dispersed within a specific chemical environment (liquid or solid), the outer surface of the flakes can be modified to enable a desired interaction with their surroundings. By way of non-limiting example, dipropylene glycol diacrylate (DPGDA) can be used as an additive, if the flakes are to be incorporated in an acrylic resin. Additives that enable future interactions of the flakes with their environment can be referred to as functionalizing additives.

Alternatively or additionally, at least one of the one or more additives modifies a rate of production of the produced flakes, all other parameters of the method being similar.

Alternatively or additionally, at least one of the one or more additives modifies a dimension of the produced flakes, for instance a length, a width, a thickness, an aspect ratio between such measurements (e.g., between an average planar size, such as approximated by D50, and an average thickness), a shape, a volume, etc., all other parameters of the method being similar.

The method can be practiced with N supply cylinders and N−1 fatiguing rod assemblies sandwiched between any two adjacent supply cylinders, or with N fatiguing rod assemblies each adjacent on a same side of the supply cylinders diametrically opposed to previous assembly, or with N+1 fatiguing rod assemblies wherein each supply cylinder is sandwiched between any two adjacent rod assemblies. Moreover, each fatiguing rod assembly may include one or two fatiguing rods. Thus, in many cases the present method can be implemented with at least one supply cylinder being contacted by at least two fatiguing rods (of a same or different rod assembly positioned on opposite sides of the cylinder). These at least two fatiguing rods can be same or different, one of the fatiguing rods being made of the second material and the same rod, or the other, being textured. In some embodiments, when at least one supply cylinders is in rolling contact with at least two fatiguing rods of one or more rod assemblies, at least one of the fatiguing rods is non-textured.

In some embodiment, the at least one fatiguing rod of a rod assembly being textured has an outer surface having an average surface roughness (Ra) greater than 0.2 μm, greater than 1 μm, greater than 2 μm, or greater than 3 μm.

In some embodiments, the at least one textured fatiguing rod is coated with a layer, or with particles, of a third material different from the first and the second material.

In some embodiments, the texture of the at least one textured fatiguing rod or a segment thereof is random. In some embodiment, the texture of the at least one textured fatiguing rod or a segment thereof follows a repeating pattern of continuous or interrupted protrusions.

When the texture of the at least one textured fatiguing rod, or a segment thereof, follows a repeating pattern, it can comprise at least one continuous protrusion or series of aligned projections having a height D of at least 3 μm, at least 50 μm, or at least 100 μm; and optionally at most 300 μm, at most 250 μm, or at most at most 200 μm. In some embodiments, the protrusion or projections optionally have a relatively flat top surface at the apex, the top surface having a width T of at least 25 μm, at least 50 μm, at least 100 μm, or at least 200 μm; and optionally at most 500 μm, at most 400 μm, or at most 300 μm; the protrusion or projections optionally having tapering faces between the surface of the rod and the apex.

In some embodiments, the at least one continuous protrusion or series of aligned projections of the textured fatiguing rod forms an angle α with respect to the axis of rotation of the fatiguing rod, the angle being 90 degrees (°) or less and optionally between 0° and 60°, between 2° and 50°, or between 5° and 45°.

In some embodiments, the at least one textured fatiguing rod comprises at least two continuous protrusions or series of aligned projections wherein a distance G between lateral edges of adjacent protrusions or adjacent projections of the at least two series is between 25 μm and 300 μm, or between 25 μm and 250 μm, or between 25 μm and 200 μm.

The supply cylinders and the fatiguing rod(s) may be caused to rotate by having at least one of them connected to a respective motor capable to drive the supply cylinders and the rods in frictional contact one with the other. In some embodiments, each supply cylinder may be associated with a respective motor. The motors may be supported to accommodate relative movement between the axes of the supply cylinders associated therewith, as the outer diameters of the supply cylinders reduce during operation.

The speed of rotation of the supply cylinders and fatiguing rods may be such that the velocities of surfaces in contact one with the other are matched. Alternatively, a relative velocity between contacting surfaces of the fatiguing rods and the supply cylinders, may be tolerated or even induced. A relative velocity of, for example, ±10% can be provoked by applying a braking force to a rod or cylinder not connected to a drive motor, or in an arrangement comprising several motors, by operating the motors at different speeds.

In some embodiments, a support cylinder may be further provided for contacting a supply cylinder that is in contact with a fatiguing rod assembly on only one side, the support cylinder being urged against the opposite side of the supply cylinder. In such cases, the support cylinder can be made of a fourth material harder than the first material from which the flakes are to be produced.

The supply cylinder can be A) constituted of a support shaft and a supply sleeve, the support shaft being journaled in a pair of bearings slidably mounted in a structure adapted for the supporting; or B) constituted of a cylinder having a central recess in its end faces, the recess serving to maintain the cylinder between a pair of tailstocks, each slidably mounted on a side of a structure adapted for the supporting. A support cylinder, if present, can be similarly constituted, the material of the sleeve or the cylinder being adapted for support.

In a further aspect of the present disclosure, there is provided a composition comprising a plurality of flakes made of a first material, the flakes having a planar surface dimension greater than an edge surface dimension, wherein at least 2% by number of the flakes comprise at least three elongate marks on the planar surface of the flake, any two adjacent marks of said at least three elongate marks having a respective longitudinal orientation deviating one from the other by 30° or less, a deviation of said longitudinal orientation of the marks from a preferred elongate mark orientation normalized for each flake being of 25° or less, wherein the flakes are coated with a second material different in nature or extent from the first material and from a native oxide thereof, which can form spontaneously on the surface of the flakes upon contact with ambient oxygen environments.

In some embodiments, each elongate mark of the flakes comprising the elongate marks is characterized by an average depth and an average width, and each two adjacent elongate marks are characterized by an average distance between the respective edges of the pair, these flakes being further characterized by one or more of the following structural features:

a) at least part of the elongate marks has an average depth of 25 nm or less;

b) at least part of the elongate marks has an average depth of 20% or less of the average thickness of the flake including the mark;

c) at least part of the elongate marks has an average width of 20 nm or less;

d) at least part of the elongate marks has an average width of 5% or less of the average thickness of the flake including the mark; and

e) at least part of the pairs of adjacent elongate marks have an average distance of 2 μm or less.

The flakes comprising the elongate marks on their planar surface typically comprise or consist of a metal, a plastic, a ceramic, or a glass material. In some embodiments, these flakes are made of metal or an alloy selected from the group comprising aluminium, brass, bronze, copper, gold, graphite, lithium, nickel, silver, stainless steel, steel, tin, and zinc. Such flakes may be referred to as metallic flakes. In a particular embodiment, the metallic flakes of the composition comprising flakes with elongate marks are made of aluminium (Al).

In a further aspect of the present disclosure, there is provided a composition comprising a plurality of metallic flakes comprising or consisting of a metal, the metallic flakes having a planar surface dimension greater than an edge surface dimension, wherein at least 2% by number of the metallic flakes comprise at least two cell blocks in the planar surface of the metallic flake, said at least two cell blocks being elongated.

The elongated cell blocks each have a respective longitudinal cell band orientation, and in some embodiments, any two adjacent elongated cell blocks have a cell band orientation deviating one from the other by 30° or less. The longitudinal cell band orientations of all cell blocks of a same flake can be averaged to define the preferred cell band orientation of the flake, which can be referred to as the normalized orientation, and in some cases the deviation between a longitudinal orientation of any cell band of the flake and the normalized orientation is of 25° or less. Metallic flakes displaying elongated cell blocks may further present elongate marks on the planar surface. In some embodiments, the metallic flakes comprising the at least two elongated cell blocks, and optionally a least three elongate marks on their planar surface, can be further coated, the composition of the coat being different from the metallic material of the core of the flake, and from a spontaneously forming native oxide thereof.

In some embodiments, the metallic flakes comprising the elongated cell blocks are made of metal or an alloy selected from aluminium, brass, bronze, copper, gold, graphite, lithium, nickel, silver, stainless steel, steel, tin, and zinc. In a particular embodiment, the metallic flakes of the composition comprising flakes with elongated cell blocks are made of aluminium.

In a further aspect of the present disclosure, there is provided a composition comprising a plurality of metallic flakes comprising or consisting of a metal, the metallic flakes having a planar surface dimension greater than an edge surface dimension, wherein at least 2% by number of the metallic flakes comprise at least one swirling pattern in the planar surface of the metallic flake.

In some embodiments, the metallic flakes comprising the swirling pattern are coated with a second material different from the metallic material of the core of the flake, and from a native oxide thereof. In a particular embodiment, the metallic flakes of the composition comprising flakes with swirling patterns are made of aluminium.

Without wishing to be bound by theory, it is believed that the presence of elongated cell blocks or swirling patterns in a planar surface of a metallic flake corresponds to the transition from a relatively crystalline structure of the material to a relatively more dislocated one. It is believed that such transition may take place when the thickness of the flakes being produced is smaller than the grain size generated by the fatiguing of the supply cylinders that led to the production of the flakes. For illustration, flakes of a same material may display cell bands at a thickness of more than 50 nm, but swirling patterns at smaller thicknesses. For each metallic material being flaked and flaking conditions, the threshold thickness between a relatively more amorphous or more organized orientation of cell bands may vary, but is generally in the low end of the nanometric range (e.g., around 50 nm or less, 40 nm or less, or 30 nm or less). In population of flakes having average thicknesses in vicinity to such thresholds, sub-populations each displaying a different type of intra-planar pattern may be found.

In a further aspect of the present disclosure, there is provided a composition comprising a plurality of metallic flakes comprising or consisting of a metal, wherein at least 2% by number of the metallic flakes have a crystallographic structure, the crystallographic structure being optionally preservable during annealing of the flakes, a preserved crystallographic structure being substantially similar before and after the annealing being one of: a) a crystallographic structure detectable by microscopic analysis, the microscopically detectable structure being selected from a group consisting of elongate striations, elongated cell blocks and swirling patterns; and b) a crystallographic structure detectable by X-ray diffraction (XRD), the XRD detectable structure being selected from a group consisting of a position of a diffraction peak, a relative intensity of a diffraction peak at a particular position and a ratio between any two diffraction peaks at two particular positions.

In some embodiments, the preservable crystallographic structure, or the preserved one if assessed after annealing, includes the elongated cell blocks which can be detected in the planar surface of the flakes by suitable microscopic analysis. In some embodiments, the metallic flakes displaying such preservable or preserved crystallographic structure comprise or consist of aluminium.

In other embodiments, the metallic flakes prepared according to the present methods can alternatively or additionally be characterized by features detectable by XRD analysis. The relative intensity of a peak can be calculated as a percentage of all diffraction peaks detectable in a spectrum scanning from 10 to 157°. Peaks detectable for flakes made of aluminium can be found inter alia at about 38.56° for a first diffraction peak corresponding to plane orientation <111> and at about 44.81° for a second diffraction peak corresponding to plane orientation <200>. In some embodiments, the ratio between the relative intensity of the first diffraction peak (i.e. <111>) to the relative intensity of the second diffraction peak (i.e. <200>), referred to herein as the XRD_{Ratio}, is for aluminium flakes of 0.40 or more, 0.45 or more, 0.50 or more, 0.60 or more, 0.70 or more, or 0.80 or more. In some embodiments, the XRD_{Ratio} can be of 2.00 or less, 1.90 or less, 1.80 or less, 1.75 or less, or 1.70 or less. In some embodiments, the XRD_{Ratio} is between 0.40 and 2.00, between 0.45 and 1.75, between 0.50 and 1.70, or between 0.80 and 1.70.

In some embodiments, the metallic flakes additionally display an appearance which can be preserved during annealing of the flakes. The appearance can be detected by any equipment suitable for assessment of optical properties. The detectable appearance, which can further be preservable, can be an optical density, a gloss value or a haze value of the flakes.

The flakes of the compositions according to any of the above-mentioned aspects, wherein at least 2% of the flakes comprise on their planar surface at least one of the elongate marks, the elongated cell blocks and the swirling patterns, the flakes optionally having an appearance and/or a crystallographic structure which may further optionally be preserved following annealing of the flakes, can in some instances further fulfill one or more of the following structural features:

i) the flakes have an average longest length of planar surface of 200 μm or less, 150 μm or less, or 75 μm or less;

ii) the flakes have an average longest length of planar surface of 50 nm or more, 250 nm or more, or 1,000 nm or more;

iii) the flakes have an average longest length of planar surface between 50 nm and 200 μm, between 250 nm and 150 μm, or between 1,000 nm and 75 μm;

iv) the flakes have an average thickness of 20 μm or less, 5 μm or less, 2 μm or less, or 1 μm or less;

v) the flakes have an average thickness of 10 nm or more, 20 nm or more, or 30 nm or more;

vi) the flakes have an average thickness of between 10 nm and 20 μm, between 20 nm and 5 μm, between 30 nm and 2 μm, or between 30 nm and 1 μm;

vii) the flakes have an average aspect ratio between the average longest length of the planar surface of the flakes and the average thickness of the flakes of 5,000:1 or less, 1,000:1 or less, 800:1 or less, 600:1 or less, or 400:1 or less;

viii) the flakes have an average aspect ratio between the average longest length of the planar surface of the flakes and the average thickness of the flakes of 3:1 or more, 5:1 or more, 10:1 or more, or 20:1 or more; and

ix) the flakes have an average aspect ratio between the average longest length of the planar surface of the flakes and the average thickness of the flakes between 3:1 and 5,000:1, between 5:1 and 1,000:1, between 10:1 and 800:1, between 20:1 and 600:1, or between 20:1 and 400:1.

In some embodiments, the dimension characterizing the planar surface of the flakes is estimated by the hydrodynamic diameter of 50% of a population of produced flakes. In such cases, the average longest length of the planar surface of the flakes can be approximated by D50 values. In some embodiments, the edge surface dimension characterizing the flakes can be their thicknesses, an average of which can be estimated by microscopic analysis of flakes cross-sections. Therefore, in some embodiments, the flakes comprising on their planar surface at least one of the elongate marks, the elongated cell blocks and the swirling patterns, as herein reported, the flakes optionally having an appearance and/or a crystallographic structure which may further optionally be preserved following annealing of the flakes, can further satisfy one or more of the following structural features:

i) the flakes have a D50 of 200 μm or less, 150 μm or less, or 75 μm or less;

ii) the flakes have a D50 of 50 nm or more, 250 nm or more, or 1,000 nm or more;

iii) the flakes have a D50 between 50 nm and 200 μm, between 250 nm and 150 μm, or between 1,000 nm and 75 μm;

iv) the flakes have an average thickness of 20 μm or less, 5 μm or less, 2 μm or less, or 1 μm or less;

v) the flakes have an average thickness of 10 nm or more, 20 nm or more, or 30 nm or more;

vi) the flakes have an average thickness of between 10 nm and 20 μm, between 20 nm and 5 μm, between 30 nm and 2 μm, or between 30 nm and 1 μm;

vii) the flakes have an average aspect ratio between D50 and the average thickness of the flakes of 5,000:1 or less, 1,000:1 or less, 800:1 or less, 600:1 or less, or 400:1 or less; and

viii) the flakes have an average aspect ratio between D50 and the average thickness of the flakes of 3:1 or more, 5:1 or more, 10:1 or more, or 20:1 or more; and

ix) the flakes have an average aspect ratio between D50 and the average thickness of the flakes between 3:1 and 5,000:1, between 5:1 and 1,000:1, between 10:1 and 800:1, between 20:1 and 600:1, or between 20:1 and 400:1.

In some embodiments, the aforesaid D50 values are established by volume of particles and in such case D50 corresponds to D_{V}50.

In some embodiments, the preservable or preserved crystallographic structure of the flakes, regardless of the method used to establish the dimensions of the flakes, is detected in flakes having a thickness in a range between 20 nm and 1,000 nm, between 25 nm and 800 nm, between 30 nm and 500 nm, between 30 nm and 250 nm, between 30 nm and 200 nm, between 30 nm and 150 nm, or between 30 nm and 100 nm.

While features of flakes produced by the present method have been presented for brevity independently, their combinations are explicitly encompassed, provided that the flakes are of a material capable of displaying each of the features.

In a further aspect of the present disclosure, there are provided compositions comprising at least 2% of flakes comprising on their planar surface at least one of the elongate marks, the elongated cell blocks and the swirling patterns, the flakes optionally having an appearance and/or a crystallographic structure which may further optionally be preserved following annealing of the flakes, the flakes being produced by a method according to the present teachings and accordingly characterized. When these flakes are further coated with a second material different from the first material of the core of the flake, and from a native oxide thereof, such coating can be achieved by selecting suitable additives to be included in the liquid which carries the produced flakes away from a supply cylinder made of the first material.

In a further aspect of the present disclosure, there are provided aluminium flakes produced by a method according to the present teachings and accordingly characterized, as briefly described above and further detailed herein. While the presence on at least 2% of the flakes (by number) of features as disclosed herein is deemed significant and sufficient to distinguish flakes prepared by the present method from conventional flakes in which such features are substantially absent, in some embodiments, at least 5%, at least 10%, at least 20%, or at least 30% (by number) of the population of flakes display the feature being considered (e.g., a pattern of striations, elongate cell bands, swirling patters, dimensions, preservable appearance, crystallographic structures and stability thereof, etc.). In some embodiments, a major proportion of the flakes being considered can display on at least one of their planar surfaces or in their planar layer the characteristic feature under consideration.

Additional objects features and advantages of the presently disclosed subject matter will be set forth in the detailed description which follows, and in part will be readily apparent to those skilled in the art from the description or recognized by practicing the presently disclosed subject matter as described in the written description and claims hereof, as well as the appended drawings. Various features and sub-combinations of embodiments of the presently disclosed subject matter may be employed without reference to other features and sub-combinations.

### BRIEF DESCRIPTION OF THE DRAWINGS

Some embodiments will now be described further, by way of example, with reference to the accompanying figures, where like reference numerals or characters indicate corresponding or like components and/or stages. The description, together with the figures, makes apparent to a person having ordinary skill in the art how some embodiments of the presently disclosed subject matter may be practiced. The figures are for the purpose of illustrative discussion and no attempt is made to show structural details of an embodiment in more detail than is necessary for a fundamental understanding of the presently disclosed subject matter. For the sake of clarity and convenience of presentation, some objects depicted in the figures are not necessarily shown to scale.

In the Figures:

FIG. 1 is a schematic diagram of a flake fabrication apparatus allowing to practice some embodiments of the method of the invention;

FIG. 2 is a simplified alternative representation of an apparatus as shown in FIG. 1, allowing to practice some embodiments of the present method with a fatiguing rod assembly having a single rod;

FIG. 3 shows an alternative embodiment in which the fatiguing rod assembly having a single rod in FIG. 2 is replaced by one having two rods;

FIG. 4 shows an alternative embodiment in which the method is practiced with three or more supply cylinders and two or more fatiguing rod assemblies sandwiched therebetween, each assembly having a single rod;

FIG. 5 shows an alternative embodiment in which the fatiguing rod assemblies having a single rod in FIG. 4 are replaced by assemblies having two rods;

FIGS. 6 and 7 schematically show plan views of the supply cylinders at the commencement a flake fabrication method and at later time point, respectively;

FIGS. 8A, 8B and 8C show three possible constructions of the supply cylinders;

FIG. 9A shows how patterning may be applied to the surface of fatiguing rods in an embodiment of the invention;

FIG. 9B shows an alternative cross section of the exemplary helical groove in FIG. 9A;

FIG. 10 displays a flow chart of a method of producing flakes according to some embodiments of the presently disclosed subject matter;

FIG. 11A is an image of the internal structure of a surface of a flake, in accordance with some embodiments of the presently disclosed subject matter, the flake comprising elongated cell blocks and FIG. 11B representing for convenience a partial graphic illustration of the same;

FIG. 12A is an image of the external structure of a surface of a flake, in accordance with some embodiments of the presently disclosed subject matter, the flake comprising elongate marks and FIG. 12B representing for convenience a partial graphic illustration of the same; and

FIG. 13A is an image of the internal structure of a surface of a flake, in accordance with some embodiments of the presently disclosed subject matter, the flake comprising swirling patterns and FIG. 13B representing for convenience a partial graphic illustration of the same.

### DETAILED DESCRIPTION

### Overview

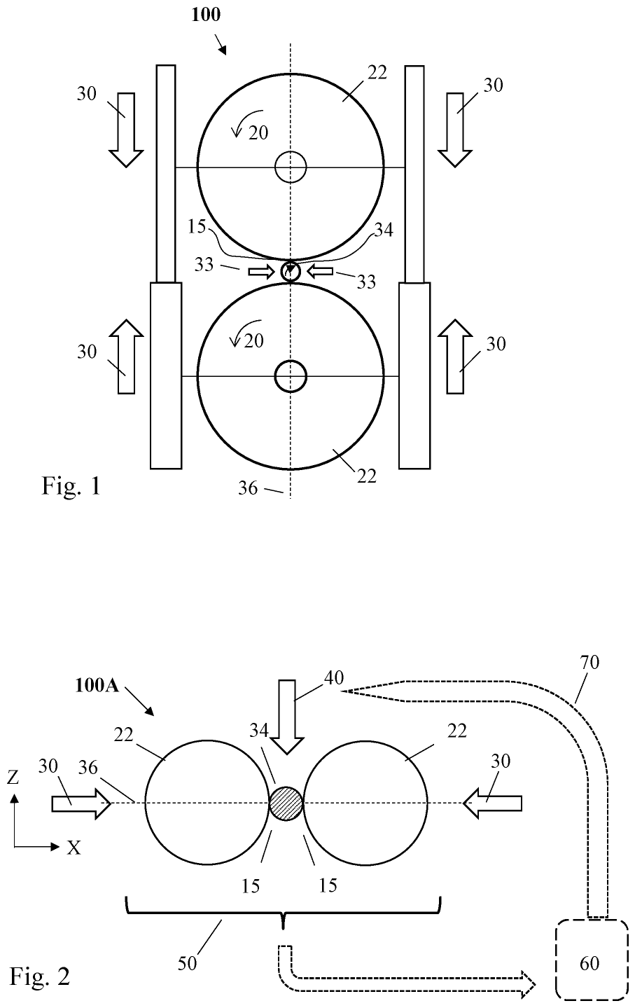

FIG. 1 is a schematic diagram of part of an apparatus 100 illustrating the method used in the present disclosure for the production of flakes. The apparatus 100 comprises two supply cylinders 22 made of the material from which flakes are to be produced and a fatiguing rod assembly, comprising a single fatiguing rod 34, sandwiched between them. The material to be flaked of the supply cylinders can also be referred to as a “first material”, whereas the material forming the fatiguing rod can also be termed a “second material”. A support structure, represented schematically by arrows 30 and 33, holds the supply cylinders 22 with their axes parallel to one another and the fatiguing rod 34 with its axis in the same plane as the axes of the two supply cylinders 22, the plane being represented in the drawing by a dotted line 36. While supported in this manner, the supply cylinders 22 are urged towards one another, as represented by arrows 30 in the drawing, to compress the fatiguing rod 34 between them and they are rotated at the same time in the directions indicated by arrows 20, so that rolling contact is made at the contact areas, designated 15 in the drawing, and also herein termed the nip, between each supply cylinder 22 and the fatiguing rod 34. While the cylinders and rod are arranged in this drawing vertically one above the other, the orientation is immaterial and they can alternatively be arranged horizontally side by side, as illustrated hereinbelow.

Because of the small diameter of the fatiguing rod 34, a high force is applied to the supply cylinders 22 over a small contact area 15, and the resulting pressure is sufficient to disturb and weaken the crystal structure of the first material at the surface of the supply cylinders 22. The repeated application and removal of this pressure as the supply cylinders 22 rotate results in their surfaces being fatigued and flaked.

To avoid the surface of the fatiguing rod 34 flaking at the same time, it should be made of a second material harder than the first material. For example, when the supply cylinders 22 are made of a metal (e.g., aluminium, copper, nickel, stainless steel, zinc, etc.), the fatiguing rod 34 may be made of a ceramic material (e.g., tungsten carbide) or of a harder same or different metal (e.g., stainless steel).

FIG. 2 is a further simplified schematic illustration of an apparatus 100A wherein the method for the production of flakes of the present disclosure can be practiced. The plane in which the axes of rotation of the supply cylinders 22 and the fatiguing rod 34 of the assembly are found are represented by a dotted line 36 horizontal in this drawing instead of vertical in FIG. 1. The method can be practiced in any other suitable orientation of the plane in which an apparatus for its implementation can be conveniently constructed. For clarity, a supporting structure and means for rotating the cylinders and rod (e.g., motors) are omitted, while the urging mechanism (e.g., a hydraulic or pneumatic piston) is symbolically represented by arrows 30.

To collect the produced flakes a fluid, preferably a liquid, is applied to any of the supply cylinders 22 and rod 34, their rotation leading the fluid to the nips 15. Aside from serving as a means of collecting the produced flakes, the liquid may serve for other purposes, such as lubrication and cooling. In embodiments to be later detailed the fluid may comprise additives which can enhance the present method.

Arrow 40 represents a device for applying such a fluid at least to parts of the nips. The fluid (and flakes therein) can be collected in a collector 50. The flakes, or a portion thereof, can optionally be separated from the fluid in an adequate separator 60 from which the fluid (and flakes remaining therein, if any) can be, if desired, recycled via a recirculating path 70 to be applied again to at least part of the nips. The order of the steps (and devices allowing their implementation) is not critical and, for instance, the fluid can first be passed through a filter to separate the desired flakes, before or without being itself collected, and may be directly recycled after filtration. The particulate matter separated from the fluid (e.g., liquid), which may only be a proportion of the flakes carried by the fluid from the surface of the supply cylinders can be thereafter collected.

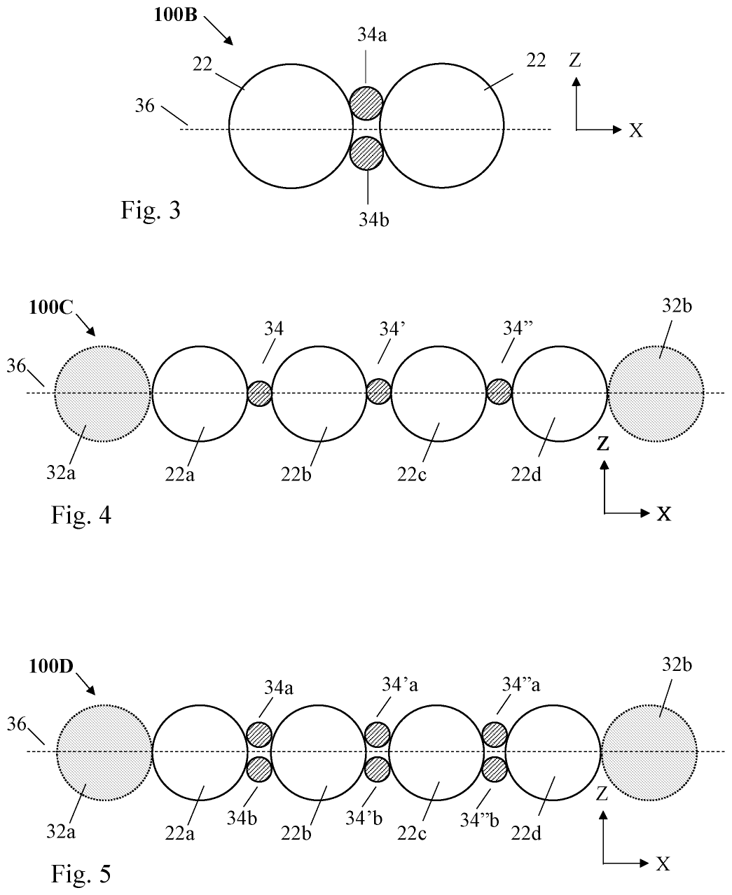

Instead of the fatiguing rod assembly comprising a single rod 34 lying with its axis in a plane containing the axes of the supply cylinders as shown in the apparatus 100A of FIG. 2, it may, as shown in the apparatus 100B of FIG. 3, comprise two rods 34a and 34b disposed, respectively, above and below the plane 36 of the axes of the supply cylinders 22. For clarity, the symbols representing a compression mechanism 30, a fluid applicator 40, a collector 50, and optional separator 60 and recycling path 70, are omitted from this schematic figure on.

A method more suited to commercial production but operating on the same principles as described above can be implemented in larger apparatuses, as schematically illustrated in FIGS. 4 and 5, wherein the sets of supply cylinders and supply rod assemblies schematically illustrated in FIGS. 2 and 3 can serve as “elementary units” being “repeated”. For clarity, the support structure, the drive motor(s) and the urging mechanisms are not shown.

FIGS. 4 and 5 show a plurality of supply cylinders 22 having their respective axis of rotation lying in a same plane and of fatiguing rod assemblies (comprising one or two rods) being disposed between any two supply cylinders facing one another. As later detailed, fatiguing rods 34, 34′, 34″, 34a, 34b, 34′a, 34′b, 34″a, and 34″b, need not be the same. In some embodiments, a supply cylinder 22 is contacted by at least one textured fatiguing rod 34. As shown in these figures, the terminal cylinders 22a and 22d of the bank of supply cylinders of apparatus 100C or 100D can further contact (on the side opposite to the rod assembly) a backing surface, represented in the drawings by optional support cylinders 32a and 32b.

While apparatuses 100C and 100D were illustrated with four supply cylinders 22a to 22d and three fatiguing rod assemblies comprising together from three to six fatiguing rods 34, the method of the present invention can be practiced with any suitable number N of supply cylinders. If the fatiguing rod assemblies are only positioned in between two adjacent supply cylinders, the method can be practiced with N−1 assemblies. However, this is not essential since rod assemblies can alternatively be additionally found on both sides of one or more of the terminal supply cylinders. In such cases, the method can be practiced with N assemblies of fatiguing rods or with N+1 assemblies of one or two rods each.

In all aforesaid embodiments, the support structure must ensure that each fatiguing rod 34 does not move in the plane perpendicular to the plane 36 of the axes of the supply cylinders 22.

While in FIGS. 1 and 2 the supply cylinders 22 are urged towards one another, compressing therebetween the fatiguing rod 34, by forces simultaneously applied in opposite directions, parallel to arrows 30 in the drawings, this is not necessarily the case. A force can be applied in a single direction (e.g., upward or downward in FIG. 1, or to the left or right in FIG. 2), optionally urging the supply cylinders and the fatiguing rod assembly sandwiched therebetween against a support surface. In such a case, and assuming the support surface is a support cylinder as illustrated by 32a and 32b in FIGS. 4 and 5, a drive motor can alternatively be used to rotate the support cylinder, instead of rotating at least one of a supply cylinder or a fatiguing rod.

The remainder of the apparatus 100 (as further exemplified in apparatuses 100A to 100D) is required to perform the following functions to enable the practice of the present method:

I. The apparatus should include a support structure, as mentioned above, to support the supply cylinders 22 in such a manner as to permit them to rotate, while allowing their axes to move towards one another.

II. The support structure should support the fatiguing rod(s) 34 and assemblies thereof, while preventing them from moving in a plane perpendicular to the plane 36.

III. The apparatus should include a mechanism for urging the supply cylinders 22 towards one another. And

IV. The apparatus should include one or more drive motors for rotating at least one of the supply cylinders, the fatiguing rods and/or the support cylinders (if present).

Aside from the above, as the apparatus is intended for commercial production of flakes, a system is required to collect the flakes generated during operation by fatiguing of the surfaces of the supply cylinders. Such collection can take place before and/or after a separation of at least a proportion of the produced flakes from the fluid.

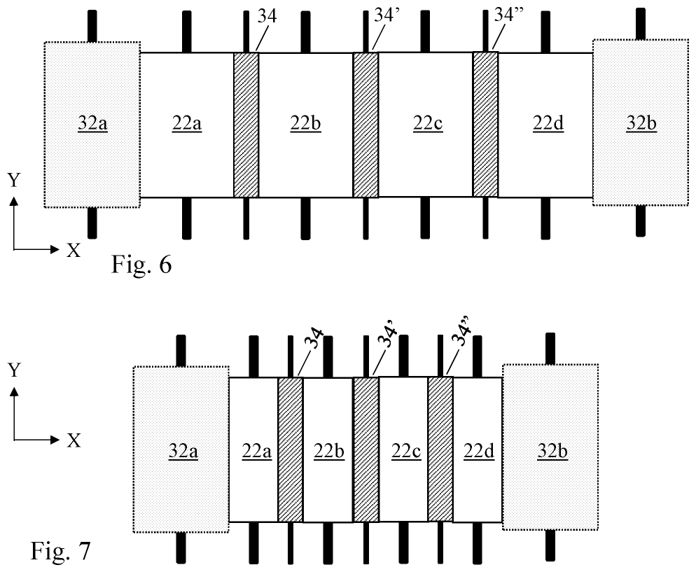

FIG. 6 shows a plan view of the bank of supply cylinders 22a-22d of FIG. 4 or 5 at the commencement of operation and FIG. 7 is a similar view after the material of the supply cylinders has been significantly consumed. The supply cylinders are deemed exhausted when reaching a minimum diameter, such as the diameter of a central shaft. It will be seen from these figures that the support cylinders 32a and 32b, when present, are not reduced in diameter during the production of flakes.

In FIGS. 6 and 7, it will be seen that there is no fatiguing rod between the end supply cylinders 22a and 22d and the adjacent support cylinders 32a and 32b. In this case, the intermediate supply cylinders 22b and 22c will be depleted more quickly than the end supply cylinders 22a and 22d, because each is in contact with two fatiguing rods (or two rod assemblies, each having two rods) rather than only one. As readily appreciated, it is possible to change the relative position of the supply cylinders in the bank of cylinders, to ensure they are similarly consumed before one of them is exhausted. It would be alternatively possible, to provide fatiguing rods between the end supply cylinders and the support cylinders but care must be taken in choosing the material to ensure that the surface of the support cylinders 32a, 32b is not caused to flake at the same time. If, for example, the supply cylinders are of aluminium, then the fatiguing rods may be of tungsten carbide and the support cylinders of stainless steel.

It is stressed that while these drawings illustrate that the bank of supply cylinders may be maintained between support cylinders at both ends, such an assembly need not be construed as limiting. A bank of supply cylinders may be supported at only one of its ends or may be devoid of support cylinders. Pressure can be applied to the axials ends of a supply cylinder or of a fatiguing assembly, and the bank of supply cylinders may be “terminated” at each of its ends by a supply cylinder 22 or a fatiguing rod 34 (or an assembly of a pair of rods). In such cases, when a support cylinder is absent from an end of the bank, the axes of the terminal element (e.g., supply cylinder 22 or fatiguing rod 34) should be maintained so that the terminal element can additionally serve as support for the other elements (e.g., supply cylinders) of the bank being urged against it, the terminal element not contacting any surface other than surfaces of the bank's elements. If for instance, the terminal element is a fatiguing rod assembly, the assembly need be maintained so as to only contact a supply cylinder on one side and nothing on the diametrically opposite side.

The supply cylinders, the fatiguing rods, and the support cylinders (when present) can be slidably mounted on a support structure, not shown in the drawings. For instance, the ends of the axes of rotation can be slidably mounted (e.g., via bearings in a carriage) on a guiding frame allowing the cylinders and the rods to freely rotate, as at least one of them is driven by a motor, and to freely move one towards the other in an X-direction as illustrated in FIGS. 2 to 7, whilst they are being urged into contact and the diameter of the supply cylinders are reduced over time as a result of flaking. A hydraulic or pneumatic piston can be used to compress the entire bank of supply cylinders 22a-22d between two support cylinders 32a and 32b. The last cylinder or rod of an assembly, serving as support to all others urged against it, can be anchored to the supporting structure so as to only permit rotation, and not displacement in the X-direction.

Having provided an overview above of apparatuses in which methods of the present disclosure can be implemented, different components of the apparatus will now be considered individually. Such components will only be detailed to the extent necessary to appreciate various embodiments of the method in which the repeated cycling of supply cylinders 22 pressed against a harder fatiguing rod 34 results in the surfaces of the supply cylinders being sufficiently fatigued for flakes to break away.

### Supply Cylinders

The supply cylinders 22 may be made of any material that is to be flaked, such as a metal, a ceramic, a plastic or a glass material. As used herein, the term metal may refer to a pure metal, an alloy, a metalloid, a composite, or any other combination that includes one or more metallic elements. Flakes made of any such metals can be referred to as metal flakes or metallic flakes.

In some embodiments, the supply cylinders may include a material that comprises primarily a metal selected from the group comprising aluminium, brass, bronze, copper, gold, graphite, lithium, nickel, silver, stainless steel, steel, tin, and zinc; or a ceramic selected from the group comprising alumina, calcite, glass (e.g., borosilicate), quartz, obsidian and talc. In some particular embodiments, the supply cylinder may include a material that comprises primarily aluminium (e.g., Al 1050, Al 1100, Al 1199, another member of the aluminium lxxx series where x represents any valid digit, Al 2024, Al 6061, Al 7075, Al A356, Al A4047 or Al RSP), or that comprises primarily stainless steel (e.g., stainless steel 17-4 PH®, stainless steel 304, or stainless steel 303). In further embodiments, the supply cylinder may be made of plastic materials (e.g., thermoplastic polymers such as poly(methyl methacrylate (PMMA) and polyether ether ketone (PEEK)) or of ceramic materials (e.g., quartz). Herein, reference to a material comprising primarily a component, means that the component constitutes a major portion of the material, which can be less than 50% by weight of the composition of the material for alloys, co-polymers or composite materials, but is typically at least 50 wt. %, such as at least 55 wt. %, at least 60 wt. %, at least 75 wt. %, at least 80 wt. %, at least 90 wt. %, at least 95 wt. %, at least 99 wt. % or 100 wt. % of the composition of the material. For simplicity, a material comprising (e.g., up to about 95 wt. %) or consisting (e.g., ≥95 wt. % or ≥99 wt. %) of a particular component (e.g., atom, molecule, or polymer) can be alternatively referred to as being made of the component. Similarly, flakes comprising or consisting of a component, as assessed with respect to the weight of the flakes, can be said to be made of the component or referred to by the name of the component. For illustration flakes made of aluminium can also referred to as aluminium flakes.

As illustrated in FIG. 8A, each supply cylinder may integrally incorporate an axle extending laterally out of the body of the cylinder being flaked, the lateral extensions being supported by the structure of the apparatus. A supply cylinder may alternatively be constituted of a support shaft and a supply sleeve as shown in FIG. 8B. In a further alternative, shown in FIG. 8C, the supply cylinder can be constituted of a cylinder having a central recess in its end faces, the recess serving to maintain the cylinder between a pair of tailstocks, each slidably mounted on a side of the support structure.

### Fatiguing Rods

Depending on the material of the supply cylinders, each fatiguing rod 34 may be made from a second material harder than the first material of the supply cylinders.

When a fatiguing assembly includes two fatiguing rods, they need not be identical. For instance, while one of the fatiguing rods may be made of a second material, the other fatiguing rod may be made of a different material. Alternatively, or additionally, the outer surfaces of each fatiguing rod of the assembly may also differ; same or different second materials and/or same or different textures of each of the fatiguing rods being as further detailed herein. The present method is characterised, in one embodiment, by the use of at least one textured fatiguing rod for the production of the flakes.

It is noted that while two different fatiguing rods may be found in a same rod assembly, for instance one rod 34a being relatively polished and the other rod 34b being relatively more textured (e.g., having a rougher outer surface or being patterned), differences between fatiguing rods may be similarly implemented with rod assemblies constituted of a single rod. Considering for illustration, supply cylinder 22b of FIG. 6 which shows a plan view of a bank of supply cylinders, fatiguing rod 34 on its left side can be different from fatiguing rod 34′ on its right side (e.g., being made of different materials and/or having different textures on their outer surfaces, at least one of the rods being textured).

Similar principle of having different fatiguing rods on diametrically opposite sides of a same supply cylinder can also be realized with rod assemblies of two rods, in which case the different rods need not be in the same assembly on a same side but can be in the two rod assemblies separated by the supply cylinder. Thus, regardless of the manner elected, in some embodiments of the present method, a same supply cylinder can be contacted by at least two fatiguing rods, at least one of the fatiguing rods being textured. The differing rods may additionally differ by any other feature of the rods, such as the materials they are made of, their diameters, or any other treatment affecting their properties.

The fatiguing rod can comprise primarily a metal or a ceramic selected from the group comprising aluminium (Al), aluminium nitride (AIN), alumina (Al₂O₃), boron carbide (B₄C), boron nitride (BN), cubic boron nitride (CBN), chromium carbide (Cr₃C₂), diamond, sapphire, silicon carbide (SiC), silicon nitride (Si₃N₄), stainless steel, steel, tantalum carbide (TaC), titanium carbide (TiC), titanium nitride (TiN), tungsten carbide (WC), and zirconia (ZrO₂). A fatiguing rod may be further coated, typically by a different and harder compound. For example, a fatiguing rod can be primarily made of tungsten carbide with a film coating including titanium (e.g., aluminium-titanium-nitride (AlTiN) and aluminium-titanium-silicon-carbon (AlTiSiC)). To the extent that a fatiguing rod is made of a material of a chemical family similar to the supply cylinder, the material making up of the rod (or a coating thereof) need be harder than the material making up the supply cylinder. For example, a supply cylinder made of aluminium alloy Al 1050, having a Vickers Hardness number of about 30 HV, can be flaked in an apparatus according to the present teachings by a fatiguing rod made of Al 7075, an aluminium alloy having a hardness of about 175 HV.

In some particular embodiments, a fatiguing rod 34, being present in the fatiguing assembly as a unique rod or as a pair of rods, may comprise primarily tungsten carbide (e.g., also including cobalt which serves as a binder), stainless steel, silicon carbide, or be made of tungsten carbide with a titanium coating (e.g., TiAIN).

In some embodiments, the fatiguing rod 34 is made up of a second material whose hardness is significantly larger than the hardness of the first material which makes up supply cylinders 22, e.g., at least 5 times, at least 10 times, at least 20 times, at least 50 times, or at least 100 times harder. For example, a fatiguing rod may comprise primarily tungsten carbide while the supply cylinders may comprise primarily aluminium or stainless steel. Taking for illustration cylinders made of tungsten carbide (WC) having a hardness of about 2600 HV, stainless steel (SST) having a hardness of about 240 HV (in a typical range of 140-350 HV) and one aluminium alloy having a hardness of 40 HV (in a typical range of 20 HV to 180 HV), then the ratio between hardness of the fatiguing rod and hardness of the supply cylinder would be about 11 for WC/SST, and about 65 for WC/Al.

Ultimately the hardness ratio depends on a) the exact composition of each cylinder and rod, and b) whether the bulk material was further treated (e.g., annealed, cold worked, hardened, heat treated or tempered), and in the affirmative to what extent (e.g., stainless steel can be tempered to be 1/16, ⅛, ¼, ½, ¾, or Full Hard), different grades being more suitable if the material is to be used for a support cylinder (relatively harder/less ductile grades being preferred), or for a supply cylinder (relatively less hard/more ductile grades being also suitable). Moreover, hardness of the cylinders outer surfaces may be modified by the process and operating conditions of the apparatus. While the relative properties of supply cylinders and fatiguing rods are provided above with respect to their hardness, a person skilled in materials and their physical properties can readily “translate” such requirements in other terms, such as strength, yield point and the like. The yield point of the fatiguing rod should be sufficient to avoid or minimize deformation and/or wear of the rod surface under the operational conditions of the apparatus and being greater than the yield point of the material of the supply cylinders.

Another important advantage of using ceramic fatiguing rods is that their Young's module is much higher than metals, so they bend less under the applied force. When the rods are bent the pressure distribution at the nip is not uniform and using ceramic fatiguing rods allows building of wider machines for the same degree of rod deflection.

It has been found that the surface finish of the fatiguing rods has a significant effect on both the quality of the flakes produced (e.g., including their dimensions) and their rate of production. While the fatiguing rods may be polished to a mirror finish (e.g., having a mean surface roughness (Ra) of 50 nm or less, or even 20 nm or less), in alternative embodiments they may be textured, and the method of the disclosure relies on the presence of at least one textured fatiguing rod being urged against a supply cylinder to be flaked. Such textures can be achieved by an increased roughness of the surface of the rods (e.g., having a Ra of 100 nm or more), as may result from the manufacturing process of the rod in absence of a smoothening step typically otherwise included. Roughness can be measured by routine methods using a profilometer suited to the surface topography. Ra can for instance be measured using a contact stylus profilometer or using a non-contact optical profilometer. In some embodiments, the roughness of the fatiguing rod (or of any other surface) shall be measured using a confocal laser microscope (LEXT OLS5000 3D of Olympus Corporation) at a magnification of ×50.

Textures can be deliberately formed by chemically etching or physically scratching the rod surface (e.g., with diamond polishing pads of desired grit) or by coating the rod surface, typically with a third material which differs from the second material of which the rod is made. The coating can be with a continuous layer of material or with discrete particles, the size of the particles contributing to the perceived resulting roughness of coat formed thereby. For instance, fatiguing rods can be coated with diamond powders incorporated during electroless nickel plating of a stainless steel rod. A wide range of roughness levels can be achieved by such methods, the Applicant having prepared rods having a roughness Ra of about 20 nm, 100 nm, 200 nm, 250 nm, 400 nm, 500 nm, 700 nm, 800 nm, 1,600 nm, 2,000 nm and 5,000 nm, and having observed a positive correlation between the roughness of the fatiguing rods and the rate flakes could be produced therewith. Without wishing to be bound by any particular theory, it is assumed that an increased roughness of the fatiguing rods may improve their contact efficiency with the surface of the supply cylinders, thus facilitating their fatiguing. As appreciated, fatiguing rods can be similarly prepared to achieve any intermediate value of surface roughness, including values above standard roughness of unpolished parts (e.g., 1,000 nm, 1,200 nm, 1,400 nm, 1,800 nm, 2,500 nm, 3,000 nm, 3,500 nm, 4,000 nm, 4,500 nm, and so on) or any greater value (e.g., 10 μm, 25 μm, 50 μm).

While the above exemplary methods result in relatively random jaggedness on the surface of the textured fatiguing rods, the rods may additionally or alternatively be patterned in a more regular manner. For instance, a pattern may be formed in the surface of a textured fatiguing rod by machining or laser cutting, or any other patterning method adapted to the material forming the rod. The pattern, in some embodiments, may be a series of annular grooves or a continuous helical groove. In such embodiments, it has been found that such parameters as the width of the groove, its pitch and its depth all affect have effect on the flake production and their value can be determined empirically based on desired flake size and flake production rate. The pattern can be considered as a “negative” pattern of grooves in the surface at the outer diameter of the fatiguing rod surface, or as a “positive” pattern of protrusions projecting from the inner diameter of the fatiguing rod (e.g., from the surface comprising the lowest portion of the grooves).

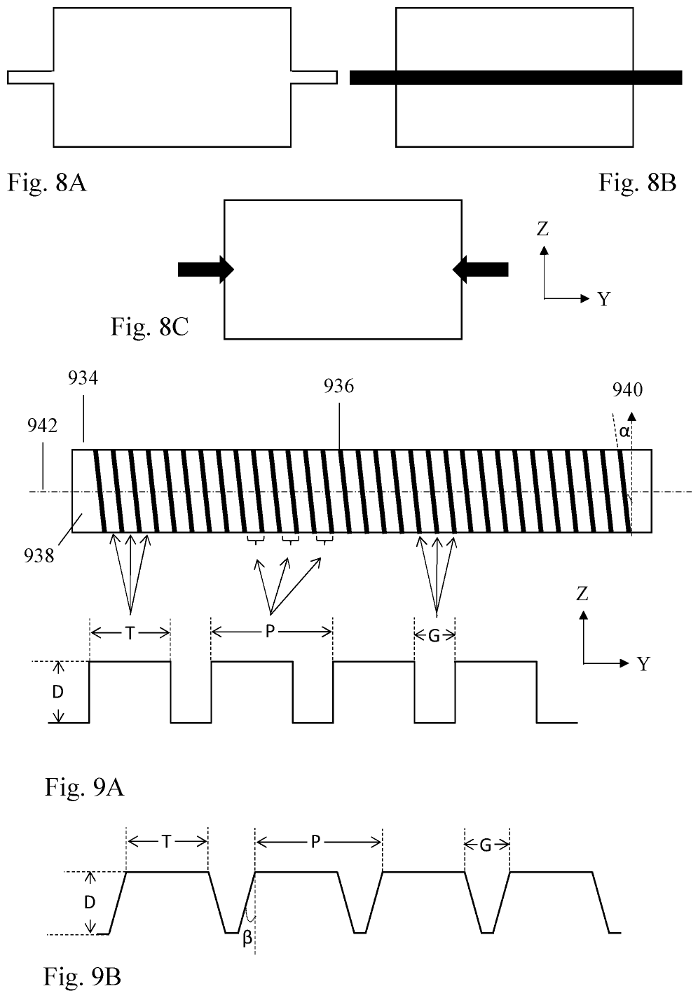

FIG. 9A shows a fatiguing rod 934 having an axis 942 and a single helical groove 936 defining raised or protruding regions 938. The helical angle α is the angle between turns of the groove and the plane 940 that is normal to the axis 942. The lower part of FIG. 9A shows to enlarged scale a section through the groove 936 to identify the different parameters of the groove 936. The width of the groove is designated G, the width of raised regions between turns of the groove is designated T, the depth of the groove is designated D. The pitch P of the groove is equal to the sum of T and G. In FIG. 9A, the groove is shown as having sides lying in a plane normal to the axis 942 but, as shown in FIG. 9B, it is alternatively possible for the sides to be inclined at an angle β.

A wide range of patterns can be formed on the surface of a textured fatiguing rod, the Applicant having prepared rods wherein the gap width G was selected from 50 μm, 60 μm, 150 μm, 160 μm, 200 μm, 230 μm, and 280 μm, the top width T was selected from 25 μm, 50 μm, 130 μm, 160 μm, 200 μm, 240 μm, and 360 μm, the groove depth D was selected from 10 μm, 35 μm, 90 μm, 160 μm, 170 μm, 190 μm, and 400 μm, and the angle α was selected from 0°, for annular grooves, and 2°, 30°, and 40°, for helical grooves. Patterns having annular grooves and helical grooves were prepared by laser cutting for the relatively thinner grooves tested on fatiguing rods made of ceramic (e.g., tungsten carbide) and by machining for the relatively larger grooves tested on fatiguing rods made of metal (e.g., stainless steel). As appreciated, fatiguing rods can be similarly patterned with parameters having any other value, including but not necessarily intermediate values.

For instance, the width of a groove G (or the distance between lateral edges of adjacent protrusions or adjacent projections) can be between 25 μm and 300 μm, or between 25 μm and 250 μm, or between 25 μm and 200 μm; the width of top surface T between two grooves can be of at least 25 μm, at least 50 μm, at least 100 μm, or at least 200 μm; and optionally at most 500 μm, at most 400 μm, or at most 300 μm; the depth D of a groove (or the height of the protrusion or projection) can be of at least 3 μm, at least 50 μm, or at least 100 μm; and optionally at most 300 μm, at most 250 μm, or at most at most 200 μm; the angle α by which a grove can be tilted with respect to the direction of rotation can be any value up to ±90°, and optionally between 0° and 60°, between 2° and 50°, or between 5° and 45°, the angle being tilted either to the right or to the left.

While FIG. 9A illustrates a single helical groove tilted to the left side of the drawing, other patterning of the fatiguing rods is possible. For example, two oppositely handed helical grooves can result in a diamond pattern on the surface of the rods, if both are designed to extend along the entire length of the rod. Alternatively, a segment of the fatiguing rod can include grooves tilted in one direction and another segment can include grooves tilted in an opposite direction. For example, half of the rod may have right-handed helical grooves and half of the rod left-handed helical grooves.

The pattern may even be random and produced by roughening the surface of the rods. In this case, chemical etching may be used as an alternative to laser cutting. The roughness may either be integral to the material of the rod or may result from a coating of the rod. If a coating is employed for providing a desired roughness to a patterned rod, the coating may be applied before or after the patterning. For illustration, a fatiguing rod can be patterned to display a helical groove and subsequently further coated with diamond particles, the size of the particles being selected in accordance with the parameters of the pattern. When a fatiguing rod displays both a pattern and a roughness, the roughness is typically measured on the top of the protrusion, on the surface between the grooves which is characterized by a width T.

In some embodiments, the diameter of the fatiguing rods 34 may be small compared to the initial diameter of the supply cylinders 22. The diameter of the fatiguing rods is relatively smaller when constituting not more than 5%, not more than 10%, not more than 15%, not more than 20%, or not more than 25% of the diameter of supply cylinder. The small diameter of the rods allows a greater pressure to be applied at the nip for a given compression force. The diameter of the fatiguing rod can also be adapted to a particular bank of supply cylinders. For instance, if a support cylinder is absent from a terminal position in an assembly of cylinders and a fatiguing rod is to serve as ultimate rolling surface, its diameter should preferably be on the larger end of the relative scale, to ease maintaining its axes of rotation stationary with respect to the force being applied to urge the cylinders in contact.

As other cylinders of an apparatus enabling implementation of a method according to the present teachings, a fatiguing rod can be journaled in a pair of bearings slidably mounted in the support structure. Any other arrangement allowing the rods to rotate, in particular when in contact with the supply cylinders, can be suitable. Such arrangements are generally configured to substantially prevent lateral displacement of the cylinders in a direction along their axes of rotation, only enabling rotation within the frame of the supporting structure in a direction essentially parallel to the force urging the supply cylinders and the rods into rolling contact. The direction the force is applied to urge the supply cylinders and the fatiguing rods together can be referred to as the X-direction and the traverse direction of their axes of rotation can be referred to as the Y-direction. The clockwise or counter-clockwise rotation of the cylinders lead to a relative displacement of their axes of rotation in the X-direction, as the material is flaked and the diameter of the supply cylinders is reduced. As mentioned, there is some tolerance in the Y-direction, and for example assuming a point of reference on a cylinder, this point may be within ±250 μm of its expected location in absence of displacement in this direction. Taking FIG. 6 for illustration, supply cylinders 22, support cylinders 32 and fatiguing rods 34 may rotate about an axis parallel to the Y-direction and move to the left or the right in the X-direction as their diameters decrease, but typically they would not be significantly displaced (e.g., by more than 250 μm) in the Y-direction, i.e. upward or downward as viewed in the drawing.

However, in some embodiments, some lateral displacement may not only be tolerated, but desirable and enabled. In such cases, in view of their smaller size, it is more convenient, though not essential, for the elements that are permitted to have their axes of rotation displaced in the Y-direction while rotating to be the fatiguing rods. Taking again FIG. 6 for illustration, and a point of reference on a fatiguing rod 34, this point would draw a sinusoid curve as the rotation of the rod and the flaking of the supply cylinders close the distance in a left to right X-direction and as the oscillation of the rod by lateral displacement along a Y-direction shifts this point up and down, in this particular view. The fatiguing rods can accordingly be referred to as oscillating between the opposite sides of the supporting structure. Usually, the peak amplitude of the oscillation, how far away the point of reference can distance itself from an ideally locked position, can be of more than 500 μm, being of 1 mm or more, 1.5 mm or more, 2 mm or more, or 2.5 mm or more.

The effect of the oscillation is inter alia to increase the production rate, if desired. To the extent that a regularly patterned rod may form repeated striations on the surface of the supply cylinder, and that such formation adversely affects the production rate of the flakes, an optimum peak amplitude of oscillation of the fatiguing rod (or a range of suitable amplitudes) can be selected to exceed the distance between the repeated striations that might otherwise have formed on the supply cylinder. The amplitude of oscillation of a fatiguing rod would depend on the nature of the patterning of the surface of the fatiguing rods and be selected so as to maintain a more even (e.g., non-patterned) surface of the supply cylinders for a longer period of time. Alternatively, or additionally, repetitive striations on the supply cylinders can be avoided, or diminished if present, by relying on a fatiguing rod lacking a regular pattern, the rod being either relatively smooth or randomly textured (e.g., rough).

### Support Cylinders

To the extent that a support cylinder 32 is included in an apparatus wherein a method according to the present teachings can be practiced, the supporting surface can be selected in accordance with the supply cylinders and fatiguing rods, its properties typically being intermediate to both. For instance, a support cylinder can be made of a fourth material, the fourth material being generally harder than the first material of the supply cylinders, but less hard than the second material of the fatiguing rod, or of a third material coating it. As previously explained, while the relative properties are illustrated above in terms of hardness, a skilled person may alternatively elect suitable combinations of materials in other terms (e.g., Young's modulus, yield point, etc.). As fatiguing rods, the supply cylinders should be selected and adapted to avoid or minimize deformation and/or wear of their surface under the operational conditions of the apparatus/method. The support cylinders can accordingly be made of any of the materials previously exemplified, if satisfying the aforesaid. Their diameter is generally larger than the diameter of the fatiguing rods, and optionally, but not necessarily, larger than the initial diameter of the supply cylinders. The support cylinders can be supported by the structure of an apparatus in any of the different ways shown in FIG. 8A to 8C for the supply cylinders, each panel exemplifying how a cylinder can be supported by a supporting structure enabling the relative movements adapted to realize the present methods. Their length can be similar to the length of the supply cylinders, but can also be slightly longer.

### Compression Mechanism

A force can be applied to compress the fatiguing rods 34 of the respective assemblies of rods between the supply cylinders 22 by means of a hydraulic ram. In alternative embodiments, a force may be applied pneumatically or by means of an electric motor. A weight can alternatively be used to create compression based on gravitational force applied via a suitable arrangement. A lever system or a gear mechanism may if necessary be employed between the motor and bank of supply cylinders. If a hydraulic system is employed, it may include an accumulator to provide damping of pressure fluctuations.

The pressure at the nip affects the rate at which flakes can be produced and their quality. If too little pressure is applied, then the flake production rate will be low. On the other hand, if too much pressure is applied then non-flake fragments and/or undesirably thick flakes may be removed from the supply cylinders. The optimum pressure is dependent inter alia on the yield strength (also referred to as yield point) and/or tensile strength of the material of the supply cylinders. It is possible to determine empirically an optimal pressure to minimize the amount of energy required to produce a given mass of flakes, in order to minimize production costs.

While compression is typically applied in one direction (e.g., from one end of a bank of supply cylinders to the other end of the bank), it may alternatively be concomitantly applied in opposite directions. In such a case, a support cylinder may optionally be inserted in a bank of supply cylinders at a position corresponding to the “terminus” of the opposite forces of compression. For illustration, assuming a bank of four supply cylinders, the supply cylinders, their fatiguing rods, and the opposite compressions forces from each end being respectively similar, a support cylinder may be included in the middle of the bank, between two pairs of supply cylinders.

Conceivably, while the illustrated embodiments present a compression being applied in one or two directions along a single line (e.g., the axes of the supply cylinders lying in a single plane), supply cylinders may be arranged radially with respect to a core cylinder (e.g., being one of the supply cylinders of the bank or being a support cylinder). In such a case, compression would be applied radially inwardly towards the core of the arrangement.

### Fluid and Additives

As earlier mentioned, a fluid can be used during operation, as illustrated by arrow 40 in apparatus 100A, the fluid being applied at least at nip(s) 15. The fluid may be a liquid or a gas of any appropriate composition. If a liquid, the fluid should preferably be adapted and selected to wet the surface of the supply cylinders from which it may assist flake removal. A liquid can suitably wet a solid if its surface tension is smaller than the surface energy of the solid to be flaked. Preferably, the fluid (if present) is elected to be compatible at least with the materials of the flakes to be prepared. By compatible, it is meant that the fluid does not adversely chemically react nor physically interact with the flakes or parts of the apparatus it may contact. For example, a fluid shall suitably not corrode a metallic flake, nor swell or otherwise deform a plastic flake. Preferably, though not necessarily, the fluid may be separated from the flakes with relative ease and can be substantially entirely removed from their surface (e.g., by direct evaporation or replacement by a more volatile solvent, to be then evaporated). However, in some embodiments, the fluid may remain at least in part with the flakes (following partial separation, if any), in which case it may be selected according to any desired post-flaking processing (e.g., flake coating) and/or according to the end-use of the flakes. For instance, a fluid can be selected so as to allow flakes to be water borne (e.g., water, alcohols, glycol ethers). If the fluid is a mixture of liquids, they are preferably, though not necessarily, miscible with one another. Furthermore, a suitable fluid shall be adapted to the operational conditions of the apparatus and for instance be workable and flowable at the operating temperature and nip pressure. For instance, liquids having a viscosity of up to 1,000 millipascal-second (mPa·s, equivalent to a centiPoise—cP) at room temperature (circa 23° C.) are typically sufficiently flowable for the present purpose, but additional viscosities can be permissible as easily determined empirically. From a practical point of view, in an apparatus wherein the fluid is recycled, the fluid shall preferably have a relatively low or moderate volatility, reducing the need to add fresh fluid to the system. In such circumstance, a fluid having a vapor pressure at room temperature not exceeding 5 kiloPascal (kPa) and preferably lower than 1 kPa or 0.1 kPa is advantageous.

The fluid can assist in flake removal e.g., by gently washing off the flakes from the surface of the supply cylinders and transporting such removed flakes away from supply cylinders, or by more forcefully removing the flakes from the supply cylinders using a jet of liquid fluid or an air knife and transporting such removed flakes away from the supply cylinders.

The fluid may by itself prevent recombination or fusion of material by maintaining the flakes separated as discrete particles; it may prevent, delay or reduce corrosion (e.g., oxidation) of flakes; and/or the fluid may counteract any deleterious effect that may be associated with flake production in an environment devoid of liquid fluid, such as flakes detonation and/or combustion.

The fluid may be liquid and include one or more liquid carriers, and optionally one or more additives and/or solid particles (e.g., flakes). A fluid may comprise or primarily comprise any of the following carriers: water (e.g., if the material of the supply cylinder is compatible with water); an alcohol, including primary, secondary and tertiary, monohydric and polyhydric alcohols; a glycol ether; a hydrocarbon; an organosilicon oil; and mixtures thereof, the foregoing list not being exhaustive. For instance, a liquid fluid may comprise an isoparaffinic hydrocarbon (e.g., as commercially provided by Exxon Mobile under Isopar™ trade name).

The fluid can alternatively be a gas (or a gas mixture), in which case it may comprise or primarily comprise air or an inert gas, such as nitrogen or argon. If a supply cylinder comprises a material whose flakes would be combustible in air and/or water (e.g., a material which comprises primarily aluminium or lithium), it may be preferable to not use air and/or water in the fluid. As additives are often supplied as solids or liquids, when the fluid is a gas or mixture thereof, the additives can be included in the fluid either in vaporized form (e.g., as aerosol) or at above their respective vapor pressure.

An additive may be, for instance, an anti-caking agent such as a fatty acid (e.g., stearic acid, oleic acid or fatty phosphonic acid), the fatty acid protecting metallic flakes from agglomeration into lumps. To some extent, fatty acid additives may also reduce oxidation, even in non-aqueous organic carriers, and optionally also act as a lubricant at the nip. In addition to or instead of an anti-caking agent, the fluid may include other additive(s) which alone or in combination may provide any benefit in comparison to a fluid composition without such other additive(s). For example, such other additive(s) may provide lubrication between fatiguing rod 34 and supply cylinder 22; and/or may include a traction fluid (e.g., Santotrac® 32) providing traction (e.g., increasing the friction) between rod 34 and supply cylinder 122; and/or may include an anti-corrosion agent (e.g., Armeen 2MCD, Ethomeen®, Lubrizol® 2064, Lubrizol® 2724, Lubrizol® 2727, Lubrizol® HPA89E2, lecithin, tallowalkyl amines, oleyl amines) which may protect surfaces being exposed by the process (e.g., on the cylinders and on the flakes) from corrosion. Additionally, or alternatively, such other additive(s) may include an anti-foaming agent, an anti-wear additive, a dispersing agent (e.g., Berol 26), a wetting agent (e.g., Aerosol® OT), a rheology modifier, a pH buffering agent, a preservative agent, and any such additive which can be beneficial to the apparatus and/or flakes made thereby. While classified for simplicity by their primordial roles, a skilled person readily appreciates that said additives may have more than one role (e.g., a same material providing lubrication, anti-wear, anti-corrosion and surfactant effects).

Such additives can be present in the fluid at any concentration suited for their purpose, but typically do not individually exceed 20%, 10% or 5% by weight of the composition. The composition of the fluid that is used may additionally or alternatively include solid particles, e.g., at a concentration of less than 20%, 10% or 5% by weight. The solid particles can be flakes previously produced, if the fluid is recycled, and/or different particles, such as solid lubricants (e.g., graphite or molybdenum disulfide (MoS₂)) or abrasive particles (e.g., silicon carbide, aluminium oxide, silica, or quartz). To the extent that the fluid used during the process of preparing the flakes at least partially remains during a post-flaking process, if any, or in the end-product, additives, when present, need advantageously be compatible with such subsequent processes and uses.

The fluid that may be used can optionally be heated or cooled, for instance, to a temperature above or below the temperature (e.g., ambient temperature) of the chamber in which apparatus 100 is located.

In some embodiments, an additive is included in the fluid to modify the chemical composition of the flakes. The “modifying” additive can be a doping agent capable of penetrating beneath the surface of the flakes, or any other chemical composition capable of adsorbing to the outer surface of the flakes. Regardless of the exact type of modification afforded to the flakes by the additive (alone or in combination with others or with the fluid) and irrespective of the localization of the modification with respect to the outer surface of the flakes, the flakes produced in presence of such modifying additives can be referred to as being “coated” with a material different from the first material at the core of the flakes and from a derivative of the first material that may naturally form in absence of the additive (e.g., a native oxide). For illustration, if an additive is included in the fluid to modify the composition of the flakes in a region adjacent to their outer surfaces, whilst they are being produced by the present method, and the flakes are made of aluminium, then the coat of the modified flakes is other than aluminium and its spontaneously forming oxide derivative alumina. Yet, it cannot be ruled out that the modified coat includes an oxide of aluminium having a chemical formula other than that of the native alumina (Al₂O₃) or having a crystalline metastable phase different therefrom. This ability of the present method to coat the flakes as they are being produced can be advantageous. It is stressed that conventional methods may not necessarily achieve such concurrent coating of flakes during their manufacturing. Some additives may be susceptible to operating conditions encountered in methods of the art which are avoided by the present method. While flakes conventionally prepared could be further processed to be enveloped by a desired compound incompatible with their mode of production, this may require more than one step to be achieved. In addition to the increased production time and cost such cumbersome manufacturing may cause, the further processing of conventional flakes with such compound may not necessarily achieve the type of interactions with the flakes providing for a desired outcome.

In an experiment wherein flakes of aluminium were produced by the present method in presence of lecithin in an isoparaffinic fluid, as detailed in the Examples section, the coating of the flakes by the additive was confirmed by X-ray photoelectron spectroscopy (XPS) analysis, which demonstrated covalent binding between the additive and the surface of the flakes.

When the present method is used to prepare doped flakes (i.e. intentionally adding a dopant material diffusing or otherwise penetrating at least in part within the flakes and not merely coating them externally), the steps can be as follows. In order to prepare flakes of a material A doped by (enriched with) atoms/molecules of a material B, the supply cylinder 22 shall comprise or consist of the material A intended to be doped, while the fluid shall include material B intended as dopant. The concentration of material B in the fluid shall depend on the desired doping level and the operating conditions of the method or apparatus implementing it. This concentration may be varied during the flaking process, for instance to maintain or control a gradient of concentration of dopant B with respect to the supply cylinder of material A. In some embodiments, the method may be further modified to ensure that at least one of the fatiguing rods 34 and support cylinder 32, when present, which is/are in rolling contact with the supply cylinder 22 includes atoms or molecules of dopant B. Without wishing to be bound by any particular theory, it is believed that the presence of the doping material in parts of the apparatus contacting the fluid, other than the supply cylinder, may favour the doping of the latter by preventing undue diversion of the dopant to the other parts contacted by the fluid. In a particular embodiment, the support cylinder is the one further comprising the material serving as dopant to the flakes, its outer surface being typically much larger than that of the rod, hence its ability to divert the dopant, were it not comprising it. To illustrate this striking application of the present doping method, the present Inventors have prepared aluminium flakes (e.g., supply cylinder made of Al 1100) using a fatiguing rod made of tungsten carbide, a support cylinder made of stainless steel 17-4 PH® (i.e., containing inter alia about 73% iron, 17% chromium and 4% nickel), and an hydrocarbon fluid (Isopar™ L) supplemented with nanoparticles of stainless steel 316L (having an average diameter of 100 nm and comprising besides iron, 16-18% of chromium, 10-12% of nickel and 2-3% of molybdenum) to serve as dopant for the aluminium flakes. The doped flakes were collected and thoroughly rinsed in IPA to remove any fluid residue and analysed for the presence of iron. The average content of iron in the doped flakes was analysed by energy dispersive X-ray spectroscopy (EDS) and found to be in the range of 6% to 10% in atomic concentration. Undoped flakes of a same material (namely prepared in a similar setup, except for the absence of stainless steel nanoparticles in the fluid) typically displayed only 0.2% atomic concentration of iron on average, as measured by the same EDS method. The doped flakes were further tested for the presence of iron within their inner core by X-ray photoelectron spectroscopy (XPS) depth profiling. Iron was found at an atomic concentration of up to about 3% at a depth of up to approximately 35 nm, confirming that the present process is capable of doping the flakes made thereby. Interestingly, the iron doping of the aluminium flakes was sufficient for the doped flakes to display paramagnetic aptitudes when subjected to a magnetic field. While doping using a method according to the present teachings was above-illustrated by using metallic particles as doping agents to a metallic supply cylinder, it is expected that such penetration of doping agents to the flakes can be similarly achieved by using a salt of the desired doping agent and/or by using a supply cylinder made of additional materials (e.g., plastic materials).

While the fluid may be continually replenished, it is preferred for it to be recycled after it has been passed through a filter to separate out the desired flakes, or conversely undesired debris. To the extent that the fluid further comprises one or more additives, and that the fluid is in part recycled, such additives may be added to the recycled or fresh fluid, so as to maintain any desired level in the fluid.

The filter may be designed to remove all the particles from the fluid before it is recycled but it in some embodiments only a proportion, preferably a major proportion, of the particles is retained in the filter. Other means can be used to separate the particles, such as by affinity, decanting, or centrifuging, to name a few. The particles that are recycled in the fluid may assist the production of further particles and may themselves be reduced in size by the recycling.

### Method of Flake Production

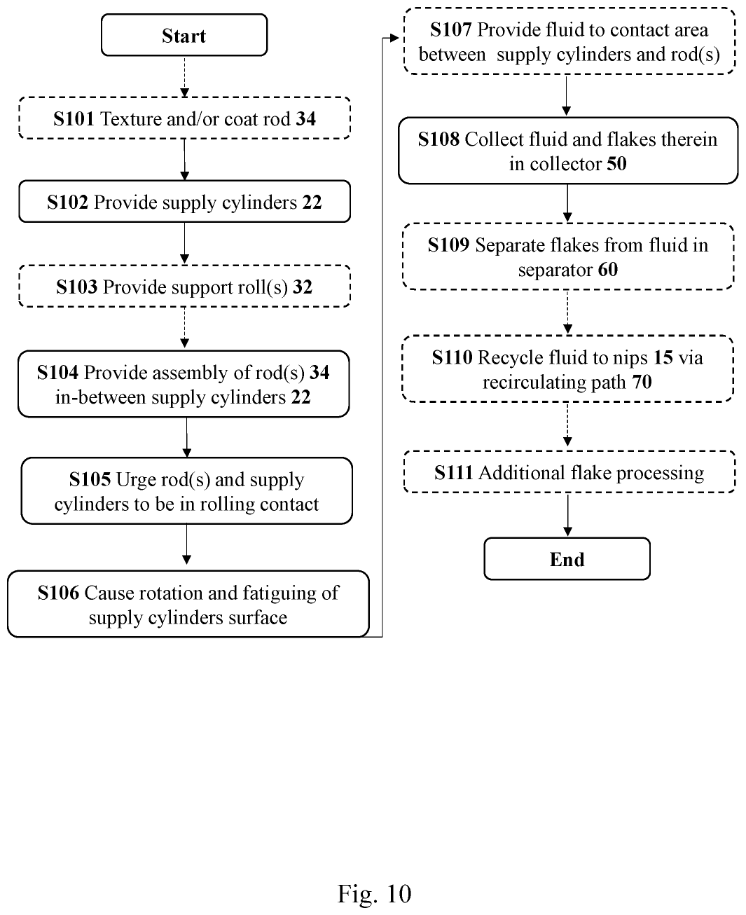

Embodiments of the method of production of the present disclosure, for instance in an apparatus as illustrated in FIGS. 1 to 7, shall now be described with reference to FIG. 10, in which dashed lines and frames relate to optional steps. One commences by selecting the material, diameter, and surface texture of the fatiguing rods 34 that is suited to the material of the supply cylinders 22 to be flaked, such selection optionally requiring as preliminary step S101 the preparation of at least one textured rod. After the supply cylinders provided in step S102 and fatiguing rod(s) assemblies provided in step S104 have been correctly stacked, eventually in presence of one or more support cylinders provided at step S103, an increasing pressure is applied in step S105 to urge and maintain the supply cylinders and the rod(s) in rolling contact, together with the support cylinders if present. While the activation of at least one motor to cause rotation is indicated in step S106, to reduce the initial torque requirement on the motor driving one of the foregoing rolls, its activation may be commenced before the pressure is ramped up in S105.

Fluid can then be applied in step S107 to the nips between the supply cylinders and the fatiguing rods in rolling contact therewith, the fluid can alternatively be applied prior to the activation of a motor causing rotation. The fluid can be collected in step S108 and the produced flakes can be separated from the fluid in step S109, or first passed through a separating device and then collected. Based on analysis of the produced flakes and their rate of production, the applied pressure and speed of rotation of the motors and cylinders associated therewith may be modified to achieve desired results. For example, the speed of rotation may be increased as the supply cylinders reduce in diameter, though this was found not to be necessary. The analysis of the produced flakes need not be performed for each run, but only if one seeks to optimize the process, or set the parameters allowing to obtain a desired type of flakes (e.g., with respect to dimensions).

After the flakes have been collected, for instance by filtration of the fluid through a sieving media adapted to retain the particles of a desired size, the separated fluid can be recycled to the nips in step S110, which recycling can alternatively be performed on the collected fluid, without prior separation. Flakes can alternatively be separated from the fluid by sedimentation, centrifugation, or any non-mechanical method suited to the materials of the flakes, as readily appreciated by persons skilled in separation of particles. Though separation of the flakes from the fluid can be done off-line and in batches, separation that can be performed in-line during the flaking process and/or in a continuous manner is deemed advantageous.

The flakes so produced, may be subjected to further processing in step S111, generally, but not necessarily following separation. Such processes may include: partial or complete separating out, breaking up, annealing, changing of the fluid (if present) and/or addition of a fluid, coating, and/or any other appropriate processing. The characteristics of the flakes that are removed from supply cylinder 22 need not necessarily be identical to the characteristics of the flakes that are collected. For example, chemical reactions may occur with one or more components of a fluid used in apparatus 100 and/or with one or more components otherwise present in the operating environment of apparatus 100. Additional processing of the produced flakes in S111 may optionally further expand the divergence between the flakes peeling away from the supply cylinders and the flakes ultimately collected.

As illustrated, the method of producing flakes according to the present teachings may include fewer, more and/or different stages than illustrated in FIG. 10, and the order of the steps may also differ.

During production of flakes by the methods herein described, supply cylinders 22 and the flakes produced therefrom were examined in numerous occasions. For an exemplary supply cylinder 22 which was made up of Al 1100, a pure alloy comprising at least 99% aluminium, it was found that flakes on the surface of the cylinder started out thick and then, as contact with fatiguing rod 34 continued, the material being “peeled” from the supply cylinder outer surface stretched and thinned out until the thinned out material broke off in flakes.

The production rate of flakes, by the methods herein described, from a given supply cylinder 22, the thickness of the flakes, and/or the characteristics of the flakes were found to vary depending on, inter alia, a) the design of the cylinders 22, the rods 34 and the support cylinders 32 (when present), including inter alia the materials from which they are each made, b) the existence and composition of the fluid, including surprisingly the presence of some additives, c) the texture (e.g., roughness or patterning) of fatiguing rods 34, d) the respective speed of any of cylinders and rods, e) the differences in cylinder speed, f) the hardness ratio between the hardness of rod(s) 34 and supply cylinders 22, g) the number of fatiguing rods in an assembly; and h) the amount of pressure.

Accordingly, the method can be adapted to produce a desired population of flakes by incorporating in an apparatus implementing it one or more controllers, each selected and adapted to control constantly or periodically at least one of:
a) the force or pressure applied by the compression mechanism;
b) the speed of rotation of at least one of the supply cylinders;
c) the speed of rotation of at least one of the support cylinders, if present;
d) at least one of the flow rate, the temperature, and the concentration of solid particles and/or additive(s) in the fluid applied to the supply cylinders; and
e) the fluid level in the collector.

### Produced Flakes

The size of the flakes being produced as herein disclosed may be determined by routine experimentation using, Dynamic Light Scattering (DLS) techniques by way of example, where the particles are approximated to spheres of equivalent scattering response and the size expressed as hydrodynamic diameter, the values observed for 50% of the population by volume or by number being respectively referred to as D_{V}50 and D_{N}50. These values, commonly alternatively referred to as D50, are often termed the average particle size. Dimensions of particles may also be estimated by microscopic methods and analysis of images captured by scanning electron microscope (SEM), transmission electron microscope (TEM), focused ion beam (FIB), and/or by confocal laser scanning microscopy techniques. Such methods are known to the skilled persons and need not be further detailed herein.

Flakes produced in accordance with some embodiments of the presently disclosed subject matter may be characterized by any suitable aspect ratio between their representative planar dimension and transverse dimension in a range from about and including 2:1 to about and including 10,000:1. A representative planar dimension of a flake can be its diameter, for flakes having the shape of a flattened sphere, or the longest length across the plane, for flakes having other shapes. A representative dimension of a flake transverse to its plane can be its thickness. Flakes prepared using an apparatus and/or a method according to any of the present teachings can have an average aspect ratio of a least about 3:1, at least 5:1, at least 10:1, at least 50:1, at least 100:1, or at least 1,000:1. In some embodiments, the flakes have an aspect ratio of at most 10,000:1, at most 5,000:1, or at most 2,000:1. The aspect ratio of the flakes may depend inter alia on the operating conditions of the method and the composition, relative hardnesses, relative diameters, and pressures perceived/applied by the respective cylinders and rods, as previously detailed. Without wishing to be bound to any particular theory, it is believed that flakes being relatively thicker may display a relatively lower aspect ratio. For instance, flakes having a thickness of a few micrometres could have an aspect ratio of 10:1, or less if on the chunky end of the range. Conversely, flakes having a relatively high aspect ratio (e.g., of 20:1 or more) are typically relatively thinner, the highest aspect ratio being typically observed for the thinnest flakes (e.g., having a thickness of 1 μm or less). Such ranges encompass the aspect ratio of flakes upon their detachment of a supply cylinder, the aspect ratio of flakes being collected and the aspect ratio of flakes being optionally further recycled with a fluid or otherwise further treated following their collection.

It is noted that the aspect ratio of flakes prepared by a particular process may vary depending on the step they are collected at, the aspect ratio being typically, but not necessarily, higher when the flake is only detaching from a supply cylinder than when it is washed away in a fluid and later collected. This stems from the fact that while it may be difficult to change the thickness of the flakes once the flakes have been removed, their diameters or longest lengths may be reduced by breaking up the flakes that have been removed and/or collected. Such variations in aspect ratio can result from the operating conditions of an apparatus implementing the method, which can, in some embodiments, be adapted or selected in order to yield the desired aspect ratio at one or more steps of the process. Additionally or alternatively, the dimensions of the flakes and their corresponding aspect ratio can be controllably modified by subsequent milling and/or other processing to reduce their size so as to obtain any suitable aspect ratio.

The flakes that are removed from supply cylinders 22 may in some cases have a higher aspect ratio than the flakes produced by ball milling and PVD, e.g., with an aspect ratio of up to 1,000:1 or 2,000:1.

A flake prepared by the present method may be characterized by a wide variety of thicknesses, from the micrometre range of a few micrometres down to sub-micron range and even low nanometre range. In some former embodiments, a flake may be characterized by a thickness of up to about 10 μm, up to about 5 μm, or up to about 1 μm. In the submicron-range, a flake may have a thickness of up to 800 nm, up to 600 nm, up to 400 nm, or up to 200 nm. In some embodiments, when the flakes are in the low nanometre range, they may have a thickness of at most 100 nm, at most 90 nm, at most 80 nm, at most 70 nm, at most 60 nm, at most 50 nm, at most 40 nm, or at most about 30 nm. In such embodiments, the flake may have a thickness of at least about 10 nm, at least 15 nm, or at least 20 nm. It is noted that the thickness of a flake may vary from edge to edge, and therefore reference herein to the thickness of a flake refers to the average thickness and the values typically reported relate to mean values obtained from a population of flakes. Such average values can be determined by analysis of micrograms captured by FIB microscopy.

The flakes produced by the present method may be additionally or alternatively characterized by one or more of the following characteristics relating to crystallographic organization, such as cell block elongation, cell block orientation, or grain boundary disruption (e.g., swirling pattern) and to surface texture (e.g., striation). Unexpectedly, some of the aforesaid crystallographic features are preserved during annealing of the produced flakes, such that elongate cell blocks detected by microscopy or diffraction peaks detected by XRD are retained and substantially similar before and after annealing, performed, for instance, for about 1 hour at 350° C.

Images of the flakes in accordance with some embodiments of the presently disclosed subject matter may be generated using STEM or Transmission Electron Microscopy (TEM) for flakes that are thinner (e.g., 200 nm or less). The parameters used for generating the images using STEM included a magnification of 20,000 or 50,000, an aperture size of 30 μm, EHT of 1 KV or 30 KV, a mix of bright field and dark field, and a low gain range.

Thicker flakes may be prepared for examination using any suitable sample metallographic preparation. For example, the flakes may be placed in an epoxy mould. The mould may then be grinded, polished and/or etched, or any such desired treatment. The treated mould may then be examined using a light microscope, Scanning Electron Microscope (SEM), or any other appropriate technology.

When examining the images (e.g., captured by STEM, 20,000 magnification) of flakes produced as herein disclosed, elongated or elongate cell blocks (also termed cell bands) were observed within the planar surface of flakes made of metals or alloys. Elongate cell blocks were observed, for instance, in flakes produced with supply cylinders 22 comprising primarily aluminium, e.g., made of Al 1100, Al 1199, or Al 6061; and on the surface of flakes removed from a given supply cylinder 22 comprising primarily stainless steel, e.g., made of 17-4 PH® stainless steel. The cell blocks were characterized as being elongate because the length of the cell block was significantly larger (e.g., at least two-fold or at least three-fold) than the width of the cell block. Such elongate cell blocks may also be referred to as cell bands. For example, six flakes produced from a supply cylinder 22 of Al 1100 had an average ratio of length to width of their elongate cell bands ranging depending on the flake from at least about 3.7 to at most about 200 (the latter occurring when the cell band spanned the entire length of the flake and the length of the flake was up to about 200 μm). The observed length of the cell bands ranged up to about 200 μm. The observed width of the cell bands ranged from about 0.3 μm to about 3 μm. In contrast, contours in ball milled flakes of such material(s) (e.g., comprising primarily aluminium or stainless steel) are not significantly elongate, meaning that a contour, if any surrounding the grain boundaries, in a planar surface of a particular conventionally prepared flake may have much more similarly sized width and length, if detectable, than cell blocks of flakes of some embodiments of the presently disclosed subject matter. In contrast, PVD flakes made of the same materials lack any such contour or cell band in their planar surface. Thus, while there have been reports of cell blocks or cell bands in bulk materials, conventionally made commercial flakes do not display such phenomenon.

The Inventors further observed that the cell bands present in the planar surface of flakes prepared according to the present teachings appeared to have a preferred orientation.

For the purposes of the presently disclosed subject matter, a preferred orientation is present when the longitudinal orientations of two adjacent cell bands in a given flake are substantially parallel or deviate from one another by an angle of no more than 30 degrees, no more than 25°, no more than 20°, no more than 15°, no more than 10°, or no more than 5°. When three or more cell bands can be detected in a same flake, an average orientation can be calculated for all measured longitudinal orientations of the flake cell bands, this average being also termed the average preferred longitudinal orientation of the flake. In some embodiments, the longitudinal orientation of each cell band of the flake deviate from the average preferred longitudinal orientation by an angle of no more than 20°, no more than 15°, no more than 10°, or no more than 5°. For such deviation from an average value to gain in statistical significance, the number of cell bands being analysed for a given flake and within the field of view provided by the microscope being used at a relevant magnification, shall preferably be of three cell bands or more, four cell bands or more, five cell bands or more, six cell bands or more. Preferably, at least 10, at least 15, at least 20, at least 25 or at least 30 cell bands should be analysed in total over all images being analysed. Such measurements can be made manually on captured images, a trained operator determining the angle generally followed by the longitudinal axis of each of the cell bands of a single flake within an arbitrarily set of x-y coordinates, then calculating the average angle of the longitudinal orientation of cell bands of the flake and how each of them deviate from the average angle of all cell bands (i.e. from the average preferred longitudinal orientation). The average angle in each flake (or each image, if encompassing a single flake) has no meaning in itself, as it may depend on the orientation of the sample with respect to the lens of the microscope. Subtracting from the angle formed by each cell band, the angle of the average preferred orientation of the corresponding flake allows assigning to each cell band of a flake a positive or negative value, the sign indicating the position of the cell band with respect to the preferred orientation. This operation, referred to herein as the normalization of the deviations in a single flake, is repeated for a number of flakes of a particular image and/or for a number of flakes in a number of different images. The accumulation of such normalized deviations for a sufficient amount of cell bands of flakes similarly prepared (e.g., of a same batch) allows calculating the average value for all absolute values of the measured normalized deviations, which can be referred to as the mean deviation (Mean_{Dev}) from a preferred orientation of a plurality of flakes displaying the cell bands, as well as the standard deviation (STD_{Dev}) of all individual normalized deviations from said mean value.

In some embodiments, the longitudinal orientation of each cell band of a plurality of flakes comprising such elongate cell blocks is such that the mean deviation (Mean_{Dev}) from a preferred orientation individually normalized for each flake of the plurality of flakes is no more than 20°, no more than 15°, no more than 10°, or no more than 5°. In particular embodiments, the standard deviation STD_{Dev} of all normalized deviations from the mean deviation Mean_{Dev} is 10° or less, 7.5° or less, of 5° or less of the mean deviation Mean_{Dev} Such measurements relating to the longitudinal orientation of cell bands and their relative orientation can alternatively be automatically performed by suitable image analysis programs along the same principles.

Without wishing to be bound by any particular theory, the Inventors posit that as fatiguing rod 34 rotates in a given direction (e.g., clockwise or counter-clockwise) against adjacent supply cylinders 22 (as depicted in any of apparatus 100), the material of the supply cylinder is stretched in a similar direction, leading to a preferred orientation of the cell bands within the planar surfaces of a resulting flake.

It should be noted that the presence of cell bands (elongate cell blocks) having a preferred orientation in metal flakes prepared according to the present teachings is deemed distinguishing and characteristic of such metallic flakes. In some embodiments, this phenomenon can be observed in at least 2% of the flakes, by number. In some embodiments, at least 5%, at least 10%, at least 20%, or at least 30% (by number) of the population of flakes display may display such cell bands. Conventionally prepared metal flakes lack such feature and would either be devoid of cell blocks or cell bands in their planar surface, as would be the case for flakes prepared for instance by PVD, or lack any preferred orientation, as would be the case for flakes prepared for instance by ball milling where cell blocks, if present, are typically randomly oriented when observed from a planar view.

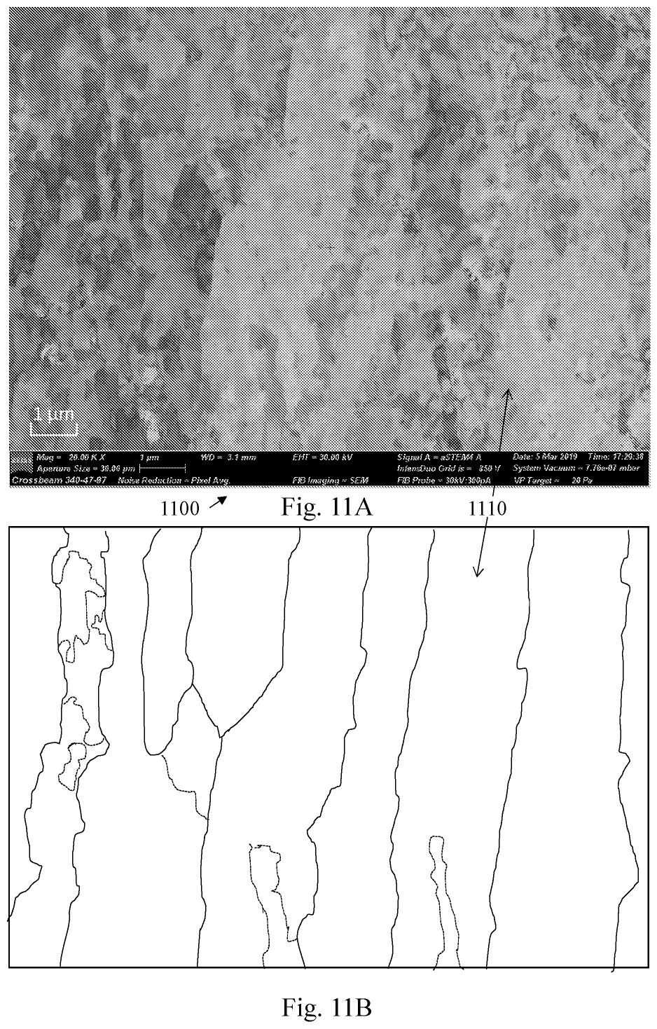

Reference is made to FIG. 11A which is an image 1100 of a flake showing its internal structure, in accordance with some embodiments of the presently disclosed subject matter. FIG. 11A is an image which shows one example of cell bands 1110 having a preferred orientation in a surface of a flake. The image was taken using STEM included a magnification of 20,000, an aperture size of 30 μm, EHT of 30 KV, a mix of bright field and dark field, and a low gain range. The material of supply cylinder 22 was Al 1199 for the flake shown in the figure, but cell bands were additionally observed in flakes of other metals or alloys. FIG. 11B is a partial graphic illustration of a flake inner structure as shown in FIG. 11A, some cell bands and their contour being schematically depicted, for convenience.

Additionally or alternatively, the flakes in accordance with some embodiments of the present subject matter were characterized in that the cell bands observed in the metallic flakes were retained and recrystallization did not occur when the flakes underwent annealing even at a temperature of up to about 350° C. For example, flakes were produced from a supply cylinder 22 primarily comprising aluminium, being made of Al 1100, Al 1199, or Al 6061. The flakes were dispersed in a fluid able to sustain heating to elevated temperatures compatible with annealing, such as Marcol® 82 (which may have been used during flake removal). The dispersions were heated for at least one hour to a number of predetermined temperatures, by steps of 50° C. between 100° C. and 350° C., such conditions being theoretically sufficient to disrupt existing cell block or cell band boundaries. STEM images were captured as previously described and it was discovered that the cell bands observed in metal flakes collected from an apparatus and/or prepared by a method according to the present teachings were surprisingly retained, regardless of the heating treatment they were subjected to. This is in contrast, for instance, with bulk material comprising primarily aluminium subjected to cold roll, whose pattern of cell blocks was reported to recrystallize at 230° C., the shape and boundaries of the blocks being disrupted at such temperature when heated for one hour.

Without wishing to be bound to any particular theory, the Inventors posit that because bulk cold rolled material comprises a large enough amount of material, material from the bulk flows during the annealing process disrupting existing cell bands, e.g., by causing new grains to appear at the boundaries of the cell bands which subsequently fuse to yield larger grains, thereby disrupting the cell bands. In contrast, because each flake in accordance with some embodiments of the present subject matter comprises a relatively small amount of material, the flakes being relatively thin as compared to bulk material, it is less likely to flow during the annealing process and therefore at up to 350° C., the cell bands that were detected before the annealing were still observed and recrystallization was not observed.

Annealing conditions, including heating rate, annealing temperature and duration, cooling rate (if the sample is cooled under a controlled regimen, rather than by passive cooling to ambient temperature), quenching conditions (if any), and the atmospheres appropriate to such experiments (e.g., in terms of pressure, vacuum conditions, or gas present) can readily be appreciated by persons skilled in the art of metallurgy. The flakes of the present disclosure can be tested for resistance to changes normally triggered by annealing under conditions adapted to the bulk material they are made of, though their minute dimensions could permit using milder conditions (e.g., lower temperatures of annealing and/or shorter durations) as appropriate to metal thin films. In some embodiments, annealing can be performed at an annealing temperature between 150° C. and 1,000° C., between 200° C. and 750° C., or between 250° C. and 500° C. In some embodiments, the heating rate is of at least 1° C. per minute, at least 5° C. per minute, at least 10° C. per minute, at least 20° C. per minute, or at least 40° C. per minute. While some metals can be annealed under air and normal atmosphere, other may benefit from annealing under vacuum conditions or under inert gases. Depending on the metal flakes and the annealing temperature being elected, the duration of annealing can be as brief as 30 minutes or as long as 3 hours, but generally the test establishing the characteristics of the flakes preservable during annealing were performed for one hour at a suitable annealing temperature.

Additionally or alternatively, flakes prepared according to the present teachings may be substantially smooth. For instance, the line surface roughness (Ra), as can be checked using atomic force microscopy (AFM), of relatively small flakes may be 10 nm root mean square (rms) or less, 8 nm rms or less, 6 nm rms or less, 4 nm rms or less, or 2 nm rms or less. For relatively larger flakes, the area roughness (Sa), as can be checked using a suitable laser confocal microscope, may be 50 μm or less, 40 μm or less, 30 μm or less, or 20 μm or less. For reference, such values indicate smooth flakes' surfaces comparable to PVD flakes and mildly smoother than ball milled flakes. For example, for supply cylinder 22 made of Al 1199, the line surface roughness of flakes obtained therefrom may be about 2 nm root mean square (rms), whereas PVD flakes may have a line surface roughness of about 1 to 2 nm rms and ball milled flakes of about 3 to 6 nm rms.

In some embodiments, one planar face of flakes according to the present teachings displayed a pattern detectable on the relatively smooth background of flakes' surfaces, the opposite face of the flakes lacking such pattern. The recurring shapes of the pattern need not be necessarily regular, nor identical with one another, nor appearing from one edge of the flake face to the other, so that the pattern displayed on one face of flakes according to the present teachings was in some embodiments present on at least a portion of a flake planar surface. Without wishing to be bound to any particular theory, as the patterns observed on flakes of a first material differ from the patterns observed on flakes of a second material, flakes of both materials having otherwise been prepared under similar conditions and in particular using a same reaction rod, the Inventors posit that the patterns are resulting from the process herein disclosed and not from an artificial experimental error or fault. For instance, it is believed that recessed patterns on a surface of the flakes are not essentially generated by corresponding protrusions on the surface of the fatiguing rod. Such patterns, whether above or below surface of a flake face, are deemed characterizing and were not observed in conventionally prepared flakes of a same material.

The repeating shapes constituting such patterns can be straight or curved lines, or any such long narrow marks, also termed herein “striations”. In one embodiment, the striations forming a pattern on one face of the flakes are recessed with respect to the surface of the flake (e.g., forming indentations, grooves or trenches). In an alternative embodiment, the striations are protruding with respect to the surface of the flake (e.g., forming projections). Expectedly, such striations are retained if the flakes are further milled to modify their dimensions and aspect ratio.

While cell bands are typically detected in metallic flakes made of metals or alloys, the pattern of striations, when present, can also be observed on flakes of additional materials (e.g., ceramics, plastics, glass). The striations are typically narrow, their average width being generally relatively smaller for flakes made from supply materials having a relatively higher hardness and typically relatively larger for flakes made from supply materials having a relatively lower hardness. In some embodiments, the striations have an average width of up to 5% of an average thickness of the flake, as measured at their base levelling with the planar surface of the flake face on which they appear. In some embodiments, the average width of the striations is at least 0.5% and at most 4% of their thickness, or between 0.5% and 3% of their thickness, or between 0.5% and 2% of their thickness. In some embodiments, the striations have an average width of up to 20 nm, up to 15 nm, up to 10 nm, or up to 5 nm.

The average depth of recessed striations (or the average height of protruding striations) is typically of up to 20% of an average thickness of the flake. In some embodiments, each striation can independently be recessed/protruding with respect to the planar surface of the flake by a depth/height of 15% or less, 10% or less, or 5% or less of the average thickness of the flake. In some embodiments, the striations have an average depth (or height) of up to 25 nm, up to 20 nm, up to 15 nm, or up to 10 nm.

As for cell bands of metallic flakes, in some embodiments, the striations on a face of a flake have a preferred orientation, the elongate marks each having a longitudinal orientation deviating from an average orientation of all striations measured on the flake by an angle of no more than 30°, no more than 25°, more than 20°, no more than 15°, no more than 10°, or no more than 5°. For such deviation from an average value to gain in statistical significance, the number of striations being analysed for a given flake and within the field of view provided by the microscope being used at a relevant magnification, shall preferably be sufficiently high and the considerations and calculations previously detailed for elongate cell blocks apply mutatis mutandis to the linear marks.

In some embodiments, the patterns that may be seen on a face of flakes prepared according to the present teachings can be further characterized by the distance between any two adjacent striations of the pattern. Such average distance (or pitch between adjacent striations) can be of 2 μm or less, 1 μm or less, 500 nm or less, 250 nm or less, 100 nm or less. In some cases, the pitch between adjacent striations of a pattern can even be of 50 nm or less, 40 nm or less, or 30 nm or less, the pitch optionally being of at least 10 nm.

As explained, such patterns of striations may appear on only one face of a flake. Moreover, they need not appear on all flakes of a population of flakes prepared according to the present teachings. Still their presence on at least 2% of the flakes (by number) is deemed significant and sufficient to distinguish flakes prepared with the present method from conventional flakes. In some embodiments, at least 5%, at least 10%, at least 20%, or at least 30% (by number) of the population of flakes display a pattern of striations, such patterns showing on at most 50% of the population (by number).

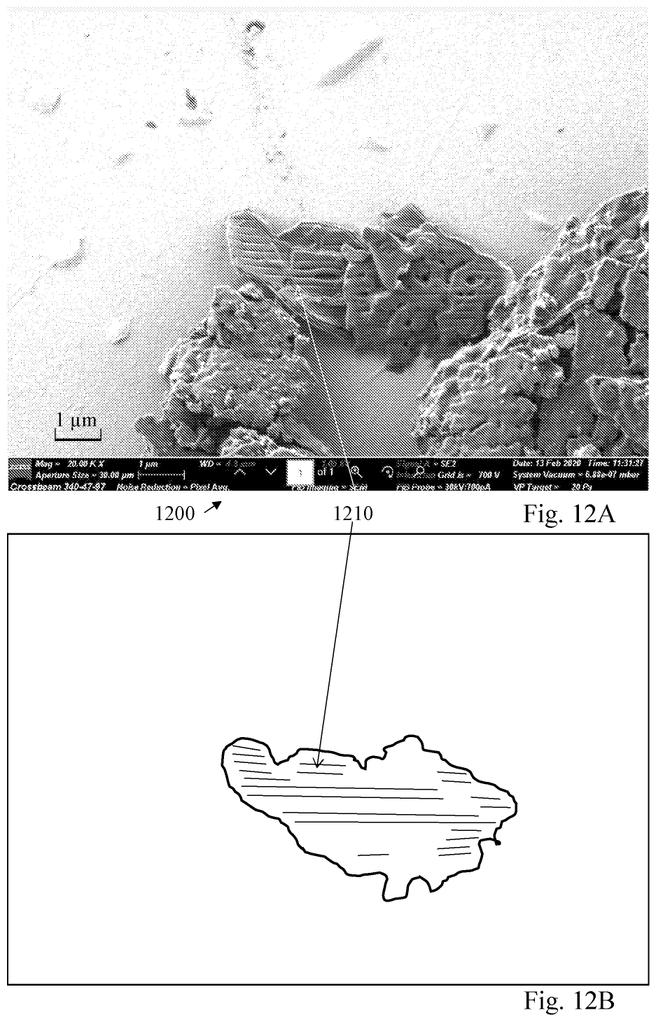

Reference is made to FIG. 12A which is an image 1200 of a surface of a flake, in accordance with some embodiments of the presently disclosed subject matter. FIG. 12A is an image which shows one example of striations 1210 having a preferred orientation on a surface of a flake. The image was taken using SEM included a magnification of 20,000, an aperture size of 30 μm, EHT of 1 KV, a mix of bright field and dark field, and a low gain range. The material of supply cylinder 22 was a plastic material consisting of PMMA for the flake shown in the figure, but elongate marks were also observed on metals (e.g., aluminium) and alloys (e.g., stainless steel). FIG. 12B is a partial graphic illustration of a flake shown in FIG. 12A, some striations being schematically shown, for convenience.

Cell bands and striations can be observed when the fatiguing rods are relatively smooth, with an average roughness of up to about 500 nm, or non-patterned, which includes non-textured rods and mildly rough ones. These two features of flakes prepared by the present method are not mutually exclusive and both may be observed in a same population of metallic flakes. A third type of flakes' feature, wherein grain boundaries appear disrupted as detailed in the following, was predominantly observed when the flakes were produced with fatiguing rods having a relatively higher roughness or being patterned, which belong to the category of the textured fatiguing rods.

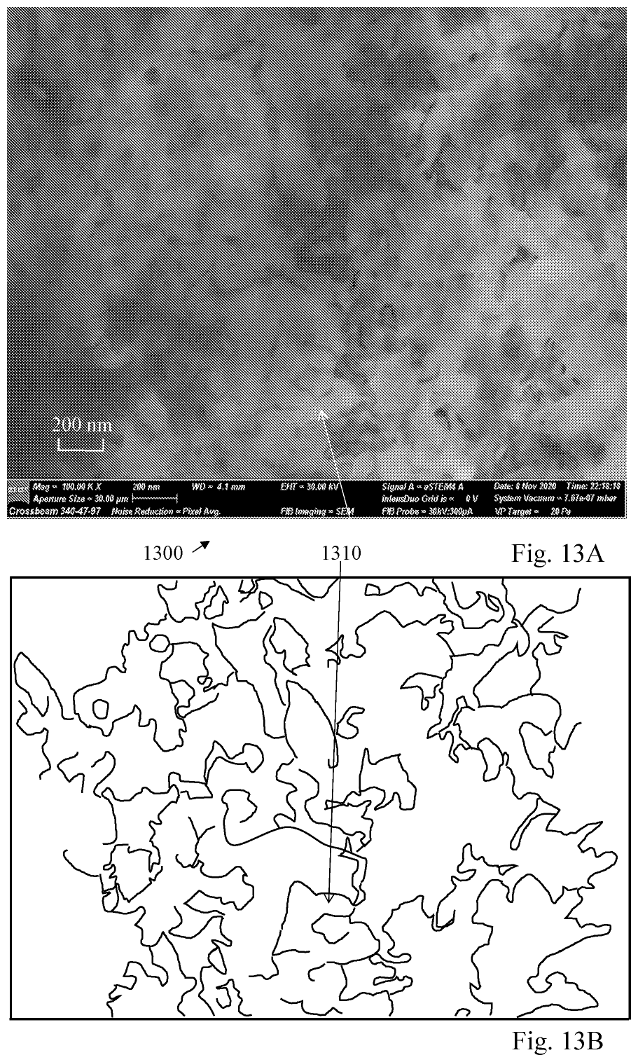

Reference is made to FIG. 13A which is an image 1300 of a flake showing its internal structure, in accordance with some embodiments of the presently disclosed subject matter. FIG. 13A is an image which shows one example of grain boundary disruptions 1310 which appear as a series of “rings” having more or less disrupted boundaries, the loops being positioned one within another and asymmetrically surrounding a core. Such features may for simplicity be referred to as swirling patterns. The image was taken using STEM included a magnification of 20,000, an aperture size of 30 μm, EHT of 30 KV, a mix of bright field and dark field, and a low gain range. The material of supply cylinder 22 was Al 6061 for the flake shown in the figure, but such swirling patterns were additionally observed in flakes of other metals or alloys. FIG. 13B is a partial graphic illustration of a flake inner structure as shown in FIG. 13A, the contour of some cell boundaries being schematically depicted, for convenience, to assist visualizing of the swirling patterns.

The industrial applicability of the present teachings was assessed for simplicity by a visual effect, as can be displayed inter alia by metallic flakes. Such effects can be readily detected by the naked eye in a fluid collecting the flakes and can be quantified, if desired. For instance, the gloss and haze of metallic flakes once applied on a flat surface can be measured by standard methods. For example, a dispersion comprising 10% by weight of flakes in a volatile solvent (e.g., IPA) can be applied by drop casting on a microscope glass slide, allowing the flakes to align to the surface of the slide as the solvent evaporates. The dry layer of particles can then be covered by a second glass slide and the underside (corresponding to the surface upon which flakes were deposited) can serve for gloss and/or haze measurements, e.g., using standard instrumentation at a 20° angle from the normal to the surface. If necessary, flakes may be cleaned of residues of fluids used in the apparatus prior to being applied on the slide, if such fluids may affect the intended measurements. For example, aluminium flakes prepared according to the present teachings displayed gloss values between 200 and 1,000 gloss units (GU), more typically between 400 and 1,000 GU, or between 600 and 800 GU. For comparison, commercially available ball milled flakes may provide under the same conditions a gloss in the range of 100 to 600 GU, but generally of no more than 200 GU. Regarding the haze that might be generated by the flakes of the present invention, the coatings so prepared displayed haze values between 500 and 1,400 haze units (HU), and generally of no more than 1,000 HU. If desired, improved outcomes can be obtained by selection (e.g., size sorting) of suitable sub-population(s) amongst the produced flakes.

In summary, flakes prepared according to the present teachings may be characterized by one or more of the following structural features, as can be routinely measured by suitable instrumentation according to procedures known to the skilled persons:
i) the flakes, if comprising or consisting of one or more metals, display within their planar surface elongate cell blocks, herein termed cell bands, a length of each cell band being at least twice a width of the same cell band;
ii) the cell bands of the flakes have a preferred orientation, a longitudinal orientation of one cell band of a flake deviating by less than 30° from the longitudinal orientations of an adjacent cell band in the same flake;
iii) the cell bands of the flakes have a preferred orientation, a longitudinal orientation of each cell band of a flake deviating by less than 25° from an average of longitudinal orientations of all cell bands of the same flake;
iv) the cell bands of the flakes have a preferred orientation, a longitudinal orientation of each cell band of a flake deviating by less than 20° from an average of longitudinal orientations of all cell bands of a plurality of similar flakes;
v) the flakes display on their planar surface striations having a preferred orientation, each longitudinal orientation of striation deviating by less than 30° from the longitudinal orientations of an adjacent striation;
vi) the flakes display on their planar surface striations having a preferred orientation, a longitudinal orientation of each striation of a flake deviating by less than 25° from an average of longitudinal orientations of all striations of the same flake;
vii) the flakes display on their planar surface striations having a preferred orientation, a longitudinal orientation of each striation of a flake deviating by less than 20° from an average of longitudinal orientations of all striations of a plurality of similar flakes;
viii) the striations have a width of 20 nm or less, as measured at their base levelling with the planar surface of the flake;
ix) the striations have a width of up to 5% of an average thickness of the flake, as measured at their base levelling with the planar surface of the flake;
x) the striations are recessed with respect to the planar surface of the flake, each striation having independently a depth of up to 25 nm;
xi) the striations are protruding with respect to the planar surface of the flake, each striation having independently a height of up to 25 nm;
xii) the striations are recessed with respect to the planar surface of the flake, each striation having independently a depth of up to 20% of an average thickness of the flake;
xiii) the striations are protruding with respect to the planar surface of the flake, each striation having independently a height of up to 20% of an average thickness of the flake;
xiv) the striations are separated from one another by a pitch of 2 μm or less;
xv) the flakes, if comprising or consisting of one or more metals, display within their planar surface swirling patterns, a width of a “ring” surrounding a core of each swirling pattern being at most 1 μm wide;
xvi) the flakes, if comprising or consisting of aluminium, display by XRD analysis at least a first diffraction peak at about 38.56° (<111>) and a second diffraction peak at about 44.81° (<200>), wherein a ratio XRD_{Ratio} between the relative intensity of the first diffraction peak to the relative intensity of the second diffraction peak is of 0.40 or more, 0.45 or more, 0.50 or more, 0.60 or more, 0.70 or more, or 0.80 or more;
xvii) the flakes, if comprising or consisting of aluminium, display by XRD analysis at least a first diffraction peak at about 38.56° (<111>) and a second diffraction peak at about 44.81° (<200>), wherein a ratio XRD_{Ratio} between the relative intensity of the first diffraction peak to the relative intensity of the second diffraction peak is of 2.00 or less, 1.90 or less, 1.80 or less, 1.75 or less, or 1.70 or less; and
xviii) the flakes, if comprising or consisting of aluminium, display by XRD analysis at least a first diffraction peak at about 38.56° (<111>) and a second diffraction peak at about 44.81° (<200>), wherein a ratio XRD_{Ratio} between the relative intensity of the first diffraction peak to the relative intensity of the second diffraction peak is between 0.40 and 2.00, between 0.45 and 1.75, between 0.50 and 1.70, or between 0.80 and 1.70;
xix) the flakes have an average longest length or a D50 of 200 μm or less, 150 μm or less, or 75 μm or less;
xx) the flakes have an average longest length or a D50 of 50 nm or more, 250 nm or more, or 1,000 nm or more;
xxi) the flakes have an average longest length or a D50 between 50 nm and 200 μm, between 250 nm and 150 μm, or between 1,000 nm and 75 μm;
xxii) the flakes have an average thickness of 20 μm or less, 5 μm or less, 2 μm or less, or 1 μm or less;
xxiii) the flakes have an average thickness of 10 nm or more, 20 nm or more, or 30 nm or more;
xxiv) the flakes have an average thickness of between 10 nm and 20 μm, between 20 nm and 5 μm, between 30 nm and 2 μm, or between 30 nm and 1 μm;
xxv) the flakes have an average aspect ratio between D50 and the average thickness of the flakes of 5,000:1 or less, 1,000:1 or less, 800:1 or less, 600:1 or less, or 400:1 or less;
xxvi) the flakes have an average aspect ratio between an average longest length or a D50 and the average thickness of the flakes of 3:1 or more, 5:1 or more, 10:1 or more, or 20:1 or more; and
xxvii) the flakes have an average aspect ratio between an average longest length or a D50 and the average thickness of the flakes between 3:1 and 5,000:1, between 5:1 and 1,000:1, between 10:1 and 800:1, between 20:1 and 600:1, or between 20:1 and 400:1.

In some embodiments, flakes prepared according to the present teachings may be characterized by two or more, three or more, four or more, five or more, six or more, or any other suitable combination amongst the features recited herein, including the twenty-seven structural features above-listed. For illustration, when the flakes are produced from a material other than a metal, they may display two or more, three or more, four or more, five or more, six or more features selected from a group including: features v) to xiv) and xix) to xxvii). When the flakes are produced from a metallic material, including if prepared from aluminium, they may display two or more, three or more, four or more, five or more, six or more features selected from a group including: features i) to xv) and xix) to xxvii). When the flakes are produced from aluminium, they may display two or more, three or more, four or more, five or more, six or more features selected from a group including features i) to xxvii), such as a) combination of features relating to the presence of cell bands in the planes of the flakes (e.g., any one or more of i) to iv)) and features relating to the presence of striations on the surface of the flakes (e.g., any one or more of v) to xiv)); b) combination of features relating to the presence of cell bands in the planes of the flakes (e.g., any one or more of i) to iv)), features relating to the presence of striations on the surface of the flakes (e.g., any one or more of v) to xiv)), and features relating to the dimensions of the flakes (e.g., any one or more of xix) to xxvii)); c) combination of features relating to particular XRD results (e.g., any one or more of xvi) to xvii)), features relating to the presence of swirling patterns in the planes of the flakes (e.g., xv)), and features relating to the dimensions of the flakes (e.g., any one or more of xix) to xxvii)); and so on. When XRD results are available, metallic flakes produced by the present method, in particular flakes made of aluminium, can in some embodiments be further characterized by their ability to retain a similar crystallographic structure before and after annealing, the preserved crystallographic features including the peaks of diffraction and their relative ratios, having in particular a highly similar XRD_{Ratio} between the relative intensity of the first diffraction peak (<111>) to the relative intensity of the second diffraction peak (<200>).

### EXAMPLES

The inventors have carried out several experiments to assess the effect of varying the various parameters mentioned above. All experiments led to the production of flakes within the ranges as herein described. Some combinations, as tested in apparatuses as depicted in FIGS. 1 to 5, are summarized in Table 1, but the detailed conditions of each experiment are not repeated herein, as they are described in GB 2593768. The interested reader is also referred to simultaneously filed PCT application No. PCT/IB2021/052742 titled “Apparatus For Making Flakes” (Agent Ref. LIP 16/006 PCT) for an explanation in greater detail of the manner in which the various supply cylinders, support cylinders and fatiguing rods may be supported by the exemplified support structures and journaled, as well as providing more information on suitable values of the different parameters that affect the production of flakes, using supply cylinders of various materials and size. Both applications are incorporated herein by reference for all purposes as if fully set forth herein.

In the table, the diameters of the cylinders or fatiguing rods are provided in millimeters (mm) and refer in the case of the supply cylinders to the initial diameter at the beginning of the experiment. If an otherwise similar assembly was tested with different diameters of cylinders or texturing of the fatiguing rod roughness thereof (e.g., roughness (provided in nm), coating and/or patterning of the reaction rod (provided in μm), all such values are listed in the cells of relevance. For brevity, NC means that a fatiguing rod is not coated, whereas NP means that a fatiguing rod is not patterned. If a rod is patterned, the relevant cells shall list the parameters of the pattern. Hence, a single line (item No.) in the below table may refer to a number of distinct experiments. Such experiments were carried out with the following fluids, their acronyms in following tables being indicated in parenthesis: air, double distilled water (DDW), butanol, ethanol, isopropanol (IPA), chloroform (CHCl₃), hexamethyldisiloxane (M2), propylene glycol methyl ether (PGM), Isopar™ E, Isopar™ L, Isopar™ M, Marcol® 82, and combinations thereof, the liquid fluids being optionally supplemented with additives as reported in more details in Table 2. All experiments were performed at a velocity of at least 70 rpm for the supply cylinders, under a pressure of at least 500 kg on supply cylinders having a length of at least 190 mm and a diameter of at least 100 mm.

TABLE 1

| | Supply | Fatiguing rod | Support cylinder |
|---|---|---|---|
| No. | cylinder (Ø) | (Ø/Ra/coating/patterning) | (Ø) |
| 1 | Al 1050 (285) | WC (Ø 10, 15, 20, 25/Ra 500/NC/NP) | SST 17-4 PH (300) |
| 2 | Al 1100 (100) | WC (Ø 5/Ra 200/NC/NP) | H13 Tool Steel |
| | | | (100) |
| 3 | Al 1100 (100) | WC or SST 17-4 PH (Ø 1, 2, 3, 5/Ra 100/ | SST 17-4 PH (100) |
| | | NC/NP) | |
| 4 | Al 1100 (100) | WC (Ø 5, 15/Ra 100/NC/NP) | SST 17-4 PH (100) |
| 5 | Al 1100 (100) | WC (Ø 5/Ra 100/NC/NP) | SST 17-4 PH (100) |
| 6 | Al 1100 (100) | WC (Ø 5/Ra 20, 100, 250, 500/NC/NP) | SST 17-4 PH (100) |
| 7 | Al 1100 (100) | WC (Ø 5/Ra 20/NC/NP) | SST 17-4 PH (100) |
| 8 | Al 1100 (65) | SST 17-4 PH (65) or Al 1100 (65)/NC/ | None |
| | | NP | |
| 9 | Al 1100 (100) | WC (Ø 5, 10/Ra 20, 100, 500/coated | SST 17-4 PH (100) |
| | | TiAlN or AlTiSiCrN)/NP | |
| 10 | Al 1100 (100) | SiC (Ø 5/Ra 100/NC/NP) | SST 17-4 PH (100) |
| 11 | Al 1100 (100) | SST 17-4 PH (Ø 5/Ra 800/NC/NP) | SST 17-4 PH (100) |
| 12 | Al 1100 (100) | Al 6061 (Ø 15/Ra 800/NC/NP) | SST 17-4 PH (100) |
| 13 | Al 1100 (120) | WC (Ø 10/Ra 400, 500, 700/NC/NP) | SST 17-4 PH (100, |
| | | | 155) |
| 14 | Al 1100 (120) | WC (Ø 10/Ra 500/NC/NP) | SST 17-4 PH (155) |
| | | With positive, negative or no skid | |
| 15 | Al 1100 (125) | WC (Ø 10/Ra 500/NC/NP) | SST 17-4 PH (300) |
| | | Pair of attrition rods per assembly | |
| 16 | Al 1100 (110) | SST 17-4 PH (Ø 10/Ra 400, 2000, 5000/ | SST 17-4 PH (155) |
| | | diamonds coated/NP) | |
| 17 | Al 1100 (125) | SST 17-4 PH (Ø 15, 25/Ra 2000/ | SST 17-4 PH (155) |
| | | diamonds coated/NP) | |
| 18 | Al 1100 (125) | WC (Ø 10/Ra 60/NC/Patterned at G 50, | SST 17-4 PH (300) |
| | | 60, 150, 200; T 25, 50, 200; D 10, 35; α° 0, | |
| | | 2, 30, 40) | |
| 19 | Al 1100 (125) | SST (Ø 25/Ra 200/NC/Patterned at G | SST 17-4 PH (300) |
| | | 160, 230, 280, 430, 650; T 130, 160, 240, | |
| | | 360; D 90, 160, 170, 190, 400; α° 2) | |
| 20 | Al 1199 (100) | WC (Ø 5, 15/Ra 20, 100/NC/NP) | SST 17-4 PH (100) |
| 21 | Al 2024 (100) | WC (Ø 1, 2, 3, 5/Ra 100/NC/NP) | SST 17-4 PH (100) |
| 22 | Al 6061 (100) | WC (Ø 1, 3, 5/Ra 100/NC/NP) | SST 17-4 PH (100) |
| 23 | Al 6061 (100) | Al 6061 (Ø 10/NC/NP) | SST 17-4 PH (100) |
| 24 | Al 6061 (285) | WC (Ø 10/Ra 500/NC/NP) | None |
| 25 | Al 6061 (285) | WC (Ø 15, 25/Ra 500/NC/NP) | SST 17-4 PH (300) |
| | | Pair of attrition rods per assembly | |
| 26 | Al 6061 (285) | WC (Ø 10/Ra 60/NC/Patterned at G 50, | SST 17-4 PH (300) |
| | | 60, 150, 200; T 25, 50, 200; D 10, 35; α° 0, | |
| | | 2, 30, 40) | |
| 27 | Al 6061 (285) | SST (Ø 25/Ra 200/NC/Patterned at G | SST 17-4 PH (300) |
| | | 160, 230, 280, 430, 650; T 130, 160, 240, | |
| | | 360; D 90, 160, 170, 190, 400; α^{°} 2) | |
| 28 | Al 7075 (100) | WC (Ø 1, 5, 10/Ra 100, 500/NC/NP) | SST 17-4 PH (100, |
| | | | 155) |
| 29 | Al A356 (130) | WC (Ø 10/Ra 200/NC/NP) | SST 17-4 PH (155) |
| 30 | Al A4047 (100) | WC (Ø 10/Ra 200/NC/NP) | SST 17-4 PH (155) |
| 31 | Al RSP (120) | WC (Ø 10/Ra 200/NC/NP) | SST 17-4 PH (155) |
| 32 | Brass [Cu:Zn | WC (Ø 10/Ra 200, 500/NC/NP) | SST 17-4 PH (155) |
| | 80:20] (100) | | |
| 33 | Bronze SAE 65 | WC (Ø 10/Ra 200/NC/NP) | SST 17-4 PH (155) |
| | (100) | | |
| 34 | Copper (100) | WC (Ø 10/Ra 400/NC/NP) | SST 17-4 PH (155) |
| 35 | PMMA (100) | WC (Ø 10/Ra 250/NC/NP) | SST 17-4 PH (100) |
| 36 | SST 304 (100) | WC (Ø 5/Ra 100/NC/NP) | SST 17-4 PH (100) |
| 37 | Tin (100) | WC (Ø 5/Ra 200/NC/NP) | SST 17-4 PH (100) |
| 38 | Zinc (100) | WC (Ø 10/Ra 200, 500/NC/NP) | SST 17-4 PH (155) |

In the below table, detailing the additives included in the experiments previously reported in Table 1, BTA refers to benzotriazole, LCT refers to lecithin, LUB refers to anti-corrosion agents selected from tallowalkyl amines, oleyl amines, and compounds commercially available as Lubrizol®, OA refers to oleic acid, ODT refers to oleyl dipropylene triamine (such as commercially available Triameen OV), PE refers to phosphate ester, SA refers to stearic acid, TF refers to traction fluid Santotrac® 32 from SantoLubes LLC, and ZDD refers to anti-wear additive ZDDPlus™.

TABLE 2

| | | Tested on arrangements reported |
|---|---|---|
| Fluid | Additive | in Table 1 as Item No. |
| Air | None | 7 |
| Butanol | None | 13 |
| Butanol | LCT | 13 |
| CHCl₃ | None | 13 |
| CHCl₃ | LCT | 13 |
| CHCl₃ Isopar ™ L | None | 13 |
| CHCl₃ + Isopar ™ L | LCT | 13 |
| DDW | None | 5, 35 |
| Ethanol | None | 7 |
| Isopar ™ E | None | 13 |
| Isopar ™ E | LCT | 13 |
| Isopar ™ L | None | 1-4, 6, 7, 9-15, 18-22, 26-29, 31, |
| | | 36, 37 |
| Isopar ™ L | BTA | 34 |
| Isopar ™ L | LCT | 1, 13-20, 22, 23, 26, 27, 29, 31, |
| | | 33, 38 |
| Isopar ™ L | LUB | 13 |
| Isopar ™ L | OA | 3, 4, |
| Isopar ™ L | OA + ZDD | 20, 21, 22, 28, |
| Isopar ™ L | ODT | 13, 17, 28 |
| Isopar ™ L | PE | 4 |
| Isopar ™ L | SA | 4, 6, 8, 32 |
| Isopar ™ L | TF | 3, 21, 22, 28 |
| Isopar ™ L | ZDD | 3 |
| Isopar ™ M | None | 13 |
| Isopar ™ M | LCT | 13 |
| IPA | None | 3, 7 |
| IPA | LCT | 3 |
| IPA | OA | 3 |
| IPA | SA | 34 |
| IPA | TF | 3 |
| IPA | ZDD | 3 |
| PGM | None | 16 |
| PGM | LCT | 16 |
| Marcol ® 82 | None | 7 |
| M2 | None | 7 |

The effect of texturing of the fatiguing rod in presence, or not, of additives in the fluid, was tested with four types of fatiguing rods, the fatiguing rod being in each experiment found in-between a pair of supply cylinders, each in turn supported by a support cylinder (i.e. an array of rolls that may be referred to as 32, 22, 34, 22, and 32, according to the references used so far). All cylinders and rods were dimensioned to have a line of contact of about 250 mm. In all experiments, the support cylinders had a diameter of 300 mm and were made of SST 17-4 PH. A first fatiguing rod, hereinafter R341, was made of tungsten carbide and had a relatively smooth outer surface with an average roughness Ra of about 50 nm and a diameter of 10 mm. A second fatiguing rod, hereinafter R342, was made of tungsten carbide and had a relatively mildly textured outer surface with an average roughness Ra of about 500 nm, achieved by rubbing the rod surface with a diamond pad progressively displaced back and forth in a direction along the axes of the rod, while the rod was rotated. R342 was tested at a diameter of 10 mm. A third fatiguing rod, hereinafter R343, was made of tungsten carbide and was regularly patterned by laser engraving to display a helical groove having a gap width G of 150 μm, an apex width T of 350 μm, a depth D of 15 μm, and an angle α of 30°. R343 was tested at a diameter of 10 mm. A fourth fatiguing rod, hereinafter R344, was made of stainless steel and was regularly patterned by machining to display a series of annular grooves (α=0°) having a gap width G of 160 μm, an apex width T of 240 μm, and a depth D of 170 μm. R344 was tested at a diameter of 25 mm.

The additives tested in this series of experiments included sodium bis(2-ethyl-1-hexyl) sulfosuccinate (an anionic surfactant such as commercially available under trade name Aerosol® OT), cocodimethylamine (a cationic oleyl amine, such as Armeen® 2MCD), a nonylphenol ethoxylate (a non-ionic antioxidant, such as available under trade name Berol 26), dipropylene glycol diacrylate (DPGDA, a difunctional reactive agent), ethoxilated amines (such as Ethomeen® C12 and Ethomeen® O12), lecithin, polyisobutylene succinimide (such as Oloa® 1200), and stearic acid.

A force of 1,000 kg.f or 2,300 kg.f was applied to the array of rods and cylinders, while the supply cylinders were set to rotate at 120 rpm, for fatiguing rods having respectively a diameter of 10 mm or 25 mm. Each experiment lasted one hour, during which a fluid comprising Isopar™ L with or without additives was applied to the nips. The additives were added at a concentration of 1 wt. % to the fluid, this amount being to be in excess for the amounts of flakes to be produced during this period of time. Typically, about 4 kg of fluid were used in each run, but the exact amount was monitored for each run. The fluid (and flakes therein) collected over the course of an experiment, was first filtered over a sieve of 500 μm, to eliminate coarse debris if any, then allowed to sediment overnight. The liquid supernatant was gently removed and a known volume of the fraction enriched with the settled flakes was sampled. Each sample was rinsed three times with Isopar™ L, then twice with isopropyl alcohol, the flakes being centrifuged at 4,000 rpm for 5 minutes between each rinsing. Following the last rinsing cycle, the flakes were dried (e.g., for about 15 minutes on a hot plate set at 100° C.), their weight determined, allowing to calculate the total weight of flakes produced per one hour of experiment. The flakes were further analysed, and their dimensions (including their average particle size (in μm), as determined by DLS per volume of particles, and their thickness (in nm), as measured by FIB microscopy) are reported in following Table 3.

TABLE 3

| | | | | Prod- | Dv50 | Thick- |
|---|---|---|---|---|---|---|
| | | | | uction | Size | ness |
| Run | Rod | | Supply | Rate | Ave. | Ave. |
| No. | No. | Additive | Cylinder | [g/h] | [μm] | [nm] |
| 1 | R341 | None | Al 1100 | 0.6 | 39 | 60 |
| 2 | R341 | Lecithin | Al 1100 | 1.45 | 28 | 55 |
| 3 | R342 | None | Al 1100 | 5.7 | 17 | 25 |
| 4 | R342 | Ethomeen ® O12 | Al 1100 | 15.1 | 24 | 40 |
| 5 | R342 | Lecithin | Al 1100 | 9.7 | 19 | 50 |
| 6 | R342 | None | Al 6061 | 21.2 | 31 | 65 |
| 7 | R342 | Lecithin | Al 6061 | 23.6 | 21 | 47 |
| 8 | R343 | None | Al 1100 | 3.5 | 41 | 45 |
| 9 | R343 | Aerosol ® OT | Al 1100 | 7.8 | 44 | 82 |
| 10 | R343 | Armeen ® 2MCD | Al 1100 | 25.3 | 35 | 50 |
| 11 | R343 | Berol 26 | Al 1100 | 11.7 | 55 | 60 |
| 12 | R343 | DPGDA | Al 1100 | 15.1 | 46 | 54 |
| 13 | R343 | Ethomeen ® C12 | Al 1100 | 18.8 | 57 | 90 |
| 14 | R343 | Ethomeen ® O12 | Al 1100 | 27.4 | 67 | 150 |
| 15 | R343 | Oloa ® 1200 | Al 1100 | 6.2 | 37 | 37 |
| 16 | R343 | Lecithin | Al 1100 | 11.3 | 42 | 100 |
| 17 | R343 | Stearic Acid | Al 1100 | 31.5 | 63 | 128 |
| 18 | R344 | None | Al 1100 | 13.2 | 37 | 60 |
| 19 | R344 | Lecithin | Al 1100 | 23.5 | 34 | 52 |
| 20 | R344 | None | Al 6061 | 15.1 | 51 | 70 |
| 21 | R344 | Ethomeen ® O12 | Al 6061 | 32.9 | 65 | 210 |

As can be seen from the above table, the texturing of the rod can affect the rate at which flakes are produced, as well as flakes' dimensions. Taking for illustration, runs 1, 3, 8 and 18, wherein flakes were produced out of Al 1100 with the four rods previously described, it can be observed that an increase in texturing can augment production rate by at least about 6-fold and up to about 22-fold in absence of additives. In presence of lecithin, see runs 2, 5, 16, and 19, the difference between relatively smooth rod R341 and patterned rod R344 similarly reaches about 16-fold increase in production rate. This effect depends on the material to be flaked, since in the case of Al 6061, the increase in texturing of the fatiguing rod, see runs 6 and 20, yielded a mild decrease in production rate. The impact on average flake size was less dramatic than on production rate and remained material-dependent under the present experimental conditions. Comparing runs 1 and 3, a decrease from an average size of about 39 μm to 17 μm was observed when replacing relatively smooth rod R341 by rougher R342 to flake Al 1100, whereas comparing runs 6 and 20, an increase from an average size of about 31 μm to 51 μm was observed when replacing relatively rough rod R342 by patterned rod R344 to flake Al 6061. Therefore, by proper selection of fatiguing rods and operating conditions adapted to supply cylinders of a material to be flaked, the present method may promote the production of flakes having desirable dimensions, said production being additionally or alternatively optimised to provide the flakes at a relatively high production rate. Suitable conditions can be empirically determined.

The results presented in Table 3 also demonstrate the effect of various additives on same parameters of production rates and flakes' dimensions. Considering, for illustration, the effect of the presence of lecithin on the productions rates achieved with Al 1100, it can be seen that this exemplary additive increased production to be at least 1.7-fold that achieved without the additive (for rod R342) and up to 3.5-fold (for rod R344). Without wishing to be bound by a particular theory, it is believed that each type of fatiguing rod may generate different types of fatiguing effects on different materials. Some fatiguing effects may include the formation of cracks in the outer surface of the supply cylinders, crack initiation, which may progress differently underneath surface, crack propagation, in presence of some additives, some of them favoring flaking. The effect of such additives may also depend on their chemical nature, as can be seen by comparing the results of runs 8-17, wherein a variety of additives were used while producing flakes from Al 1100, using patterned rod R343. While the relatively less potent additives (see runs 9 and 15) caused about 2-fold increase in production rate, the most potent additive tested in the present study, stearic acid in run 17, led to a 9-fold increase. This same additive also yielded flakes having an increased average size of about 63 μm, as compared to about 41 μm in absence of the additive. Three other additives amongst those tested, see runs 11, 13 and 14, also displayed significant increase in the size of the flakes (as well as in productions rates).

Incidentally, the average particle size, as assessed by the measurement of D_{V}50, is not the sole dimension being affected by the presence of additives. It can be seen from the results reported in Table 3 that the thickness of the flakes can also be controlled by selection of an appropriate additive. In some cases, an additive may modify the average size of the flakes and their average thicknesses, so that the produced flakes may retain a similar aspect ratio with this specific additive as compared to none or to another additive. See for illustration runs 6 and 7, which display relatively similar aspect ratios in spite of the fact that the additive modified the flakes dimensions. Alternatively, the additive may modify the average size of the flakes and/or their average thicknesses to such an extent, and/or in opposite directions, so that the aspect ratio of the produced flakes can be significantly affected. See for illustration run 14, in which Ethomeen® 012 led to an increase in the average size of the flakes from about 41 μm to 67 μm, and concurrently to a dramatic increase in flakes' average thickness from about 45 nm to 150 nm. The aspect ratio was therefore shifted from about 1:911 in absence of additive to about 1:447. A similar effect was observed with this additive on Al 6061, see runs 20 and 21. As reported in the table, other additives impacted the aspect ratio between the thickness and the average size of the flakes.

Experiments were carried out to analyse some of the features of flakes produced by the present method and their outcome reported above. Various microscopic techniques have been used to identify characteristics such as the elongated marks, the elongate cell blocks, the swirling patterns, their dimensions, spacing or relative orientation, as well as the dimensions of the flakes. Other flake dimensions were assessed by DLS. All aforesaid techniques have been mentioned upon disclosure of the reported features and are known to the skilled persons who may independently perform similar measurements by using any suitable equipment.

Analysis of the crystallographic structure of aluminium flakes by XRD was performed on pellets of compressed flakes. About 0.6 g of flakes were placed in a stainless steel die having a diameter of 13 mm and a depth of 25 mm. The flakes were compressed at increasing pressures of up to 170 MPa for up to five minutes until a cohesive pellet having a thickness of about 2.5-5 mm was formed. Pellets 1 and 2 were made of flakes prepared from Al 6061 and pellet 3 was made of flakes prepared from Al 1100. The pellets were then analysed by XRD (X'Pert³ by Malvern Panalytical) using a theta-2theta setup in the range of 10-157° by step size of 0.013° and scan step time of 13.77 seconds. Divergence slit was fixed at 0.4354°, corresponding to 10 mm beam width. Anode material used was Cu and generator settings were 40 mA and 45 kV. Diffraction peaks of generally, but not necessarily, decreasing intensities were detected at about 38.56°, 44.81°, 65.17°, 78.33°, 82.53°, 99.18°, 112.05°, 116.65° and 137.46°, corresponding to plane orientations <111>, <200>, <220>, <311>, <222>, <400>, <331>, <420> and <422>. The intensities of all diffraction peaks detected for each pellet were summed up and the relative intensity of each peak was thereafter calculated as a percentage of all peaks' total intensity. Values calculated for the four highest diffraction peaks are reported in following Table 4, other peaks having relative intensities of less than 5%.

TABLE 4

| | Peak 1 | Peak 2 | Peak 3 | Peak 4 | |
|---|---|---|---|---|---|
| | 38.56° | 44.81° | 65.17° | 78.33° | Peak 1/ |
| Sample | <111> | <200> | <220> | <311> | Peak 2 |
| Pellet 1 | 37.36% | 21.59% | 13.89% | 10.77% | 1.73 |
| Pellet 2 | 33.70% | 20.52% | 16.88% | 11.77% | 1.64 |
| Pellet 3 | 19.62% | 43.35% | 10.85% | 12.22% | 0.45 |

As the relative intensities from the third diffraction peak onward were relatively similar for the three samples tested, the results obtained from the first two peaks were used to further characterize the flakes constituting the pellets. A ratio between the relative intensity of the first diffraction peak (<111>) to the second diffraction peak (<200>) (XRD_{Ratio}) was found appropriate for this purpose. In some embodiments, this ratio for aluminium flakes is 0.40 or more, 0.45 or more, 0.50 or more, 0.60 or more, 0.70 or more, or 0.80 or more. This ratio can be of 2.00 or less, 1.90 or less, 1.80 or less, 1.75 or less, or 1.70 or less. In some embodiments, the ratio between the relative intensity of the first diffraction peak at about 38.56° (<111>) to the second diffraction peak at about 44.81° (<200>), as measured by XRD on pellets of aluminium flakes, is between 0.40 and 2.00, between 0.45 and 1.75, between 0.50 and 1.70, or between 0.80 and 1.70.

As flakes produced by the present method surprisingly displayed an ability to retain during annealing crystallographic properties detectable by microscopic analysis, such as elongate cell bands visible by STEM, this phenomenon was further investigated by performing XRD studies. The XRD patterns of aluminium flakes before and after such a process, during which the temperature was step-wisely raised to about 350° C. by steps of 20° C. a minute and maintained at this elevated temperature for one hour, were compared. The samples, corresponding to annealed versions of pellets 1 and 2, were tested as described above and found to display diffraction peaks of similar intensities (and positions) before and after annealing, therefore substantially preserving the same crystallographic structure, as expressed inter alia by the XRD_{Ratio} herein described. The annealed version of pellet 1 displayed a first diffraction peak (<111>) having a relative intensity of 39.7% and a second diffraction peak (<200>) having a relative intensity of 21.1%, yielding a XRD_{Ratio} of 1.88, as compared to 1.73 before annealing. The annealed version of pellet 2 displayed a first diffraction peak (<111>) having a relative intensity of 32.6% and a second diffraction peak (<200>) having a relative intensity of 20.6%, yielding a XRD_{Ratio} of 1.58, as compared to 1.64 before annealing.

This is unexpected, since commercially available aluminium flakes tested for comparison under the same conditions, displayed on the contrary a disappearance of some of their peaks of diffraction and a significant modification of ratio of relative intensities before and after annealing. Anecdotally, while the annealing of the commercial flakes led to a dramatic change in their look, from silvery to dark in one case and to whitish in another case, the flakes produced by the present method retained a similar silver-like appearance. This suggests that flakes of the present disclosure are better protected against oxidation, regardless of chemical anti-oxidants, as such agents would have been destroyed during the annealing process. Without wishing to be bound by a particular theory, it is believed that the present process can enable the formation of a protective shell of alumina to an extent sufficient to prevent, reduce, or delay the oxidation of the core aluminium, this coat possibly differing from a native oxide (e.g., by chemical composition or crystalline structure) that would have formed on commercially available flakes. This was demonstrated under extreme conditions of annealing, but also observed under regular storage conditions. Therefore, in some embodiments the flakes have an appearance which can be preserved and be highly similar before and after annealing.

In summary of this study, the flakes produced by the present method are relatively stable under elevated temperatures, such as those experienced during annealing. This stability encompasses the appearance of the flakes and their crystallographic structure, which remains relatively similar before and after heat treatment. The crystallographic structures that can characterize the present flakes and the compositions comprising them, and which in some embodiments can furthermore be preserved during annealing of the flakes, can be a) a crystallographic structure detectable by microscopic analysis selected from a group consisting of elongate striations, elongated cell blocks and swirling patterns; and b) a crystallographic structure detectable by X-ray diffraction selected from a group consisting of a position of a diffraction peak, a relative intensity of a diffraction peak at a particular position and a ratio between any two diffraction peaks at two particular positions. In some embodiments, the feature being considered for comparison (e.g., OD, gloss value, striations, cell blocks, or swirling patterns dimensions or orientation, XRD results, etc.) is deemed substantially similar before and after annealing if its measurements at the two time points are within 10% of the highest value of the two. Taking for illustration the XRD results of pellet 1 and 2, the first diffraction peaks have respectively a relative intensity of 37.4% or 33.7% before annealing and a relative intensity of 39.7% or 32.6% after annealing, hence the first peak of pellet 1 being within the range of 39.7%±4.0% and the first peak of pellet 2 being within the range of 33.7%±3.4% are substantially similar before and after annealing. In the present XRD comparison, and based on like calculations, the second diffraction peaks of pellets 1 and 2 are also substantially similar, as well as their XRD_{Ratio}. In some embodiments, measurements of a feature can be substantially similar before and after annealing if the two values are within 8% of the highest value of the two, within 6%, within 4%, or within 2% one from the other.

While, for the sake of illustration, this disclosure has been described in terms of certain embodiments and generally associated methods, alterations and permutations of the embodiments and methods will be apparent to those skilled in the art based upon Applicant's disclosure herein. The present disclosure is to be understood as not limited by the specific embodiments described herein. It is intended to embrace all such alternatives, modifications and variations and to be bound only by the spirit and scope of the disclosure and any change which come within their meaning and range of equivalency.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Unless otherwise stated, the use of the expression “and/or” between the last two members of a list of options for selection indicates that a selection of one or more of the listed options is appropriate and may be made.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

In the disclosure, unless otherwise stated, adjectives such as “substantially”, “approximately” and “about” that modify a condition or relationship characteristic of a feature or features of an embodiment of the present technology, are to be understood to mean that the condition or characteristic is defined to within tolerances that are acceptable for operation of the embodiment for an application for which it is intended, or within variations expected from the measurement being performed and/or from the measuring instrument being used. When the terms “about” and “approximately” precede a numerical value, it is intended to indicate +/−15%, or +/−10%, or even only +/−5%, and in some instances the precise value. Furthermore, unless otherwise stated, the terms (e.g., numbers) used in this disclosure, even without such adjectives, should be construed as having tolerances which may depart from the precise meaning of the relevant term but would enable the invention or the relevant portion thereof to operate and function as described, and as understood by a person skilled in the art.

In the description and claims of the present disclosure, each of the verbs “comprise”, “include” and “have”, and conjugates thereof, are used to indicate that the object or objects of the verb are not necessarily a complete listing of features, members, steps, components, elements or parts of the subject or subjects of the verb. Yet, it is contemplated that the compositions of the present teachings also consist essentially of, or consist of, the recited components, and that the methods of the present teachings also consist essentially of, or consist of, the recited process steps.

As used herein, the singular form “a”, “an” and “the” include plural references and mean “at least one” or “one or more” unless the context clearly dictates otherwise. At least one of A and B is intended to mean either A or B, and may mean, in some embodiments, A and B.

Positional or motional terms such as “upper”, “lower”, “right”, “left”, “bottom”, “below”, “lowered”, “low”, “top”, “above”, “elevated”, “high”, “vertical”, “horizontal”, “backward”, “forward”, “upstream” and “downstream”, as well as grammatical variations thereof, may be used herein for exemplary purposes only, to illustrate the relative positioning, placement or displacement of certain components, to indicate a first and a second component in present illustrations or to do both. Such terms do not necessarily indicate that, for example, a “bottom” component is below a “top” component, as such directions, components or both may be flipped, rotated, moved in space, placed in a diagonal orientation or position, placed horizontally or vertically, or similarly modified.

Unless otherwise stated, when the outer bounds of a range with respect to a feature of an embodiment of the present technology are noted in the disclosure, it should be understood that in the embodiment, the possible values of the feature may include the noted outer bounds as well as values in between the noted outer bounds.

To the extent necessary to understand or complete the disclosure of the present disclosure, all publications, patents, and patent applications mentioned herein, including in particular the applications of the Applicant, are expressly incorporated by reference in their entirety for all purposes as is fully set forth herein.

1.-35. (canceled)

36. A composition comprising a plurality of flakes made of a first material, the flakes having a planar surface dimension greater than an edge surface dimension, wherein a major proportion of the flakes have on at least one of their planar surfaces at least one of a following structural feature: a) at least three elongate marks, any two adjacent marks of said at least three elongate marks having a respective longitudinal orientation deviating one from the other by 30 degrees or less, a deviation of said longitudinal orientation of the marks from a preferred elongate mark orientation normalized for each flake being of 25° or less; b) the first material comprises or consists of a metal and the metallic flakes comprise at least two cell blocks in the planar surface of a metallic flake, said at least two cell blocks being elongated; and c) the first material comprises or consists of a metal and at least 2% by number of the metallic flakes comprise at least one swirling pattern in the planar surface of the metallic flake, a width of a “ring” surrounding a core of each swirling pattern being at most 1 μm wide.

37. A composition as claimed in claim 36, wherein the flakes of the major proportion are characterized by having elongate marks and the first material comprises or consists of a metal, a plastic, a ceramic, or a glass material.

38. A composition as claimed in claim 37, wherein each elongate mark is characterized by an average depth and an average width, and each two adjacent elongate marks are characterized by an average distance between the respective edges of the pair, the flakes comprising the elongate marks being further characterized by one or more of the following structural features:
a) at least part of the elongate marks has an average depth of 25 nm or less;
b) at least part of the elongate marks has an average depth of 20% or less of the average thickness of the flake including the mark;
c) at least part of the elongate marks has an average width of 20 nm or less;
d) at least part of the elongate marks has an average width of 5% or less of the average thickness of the flake including the mark; and
e) at least part of the pairs of adjacent elongate marks has an average distance of 2 μm or less.

39. A composition as claimed in claim 38, wherein the flakes having the elongate marks comprise or consist of a metal and have at least one of an appearance and a crystallographic structure preservable during annealing of the metallic flakes, the preservable appearance and/or crystallographic structure being substantially similar before and after the annealing being one of: a) an appearance detectable by spectrophotometer or gloss meter, the detectable appearance being selected from an optical density, a gloss value and a haze value; b) a crystallographic structure detectable by microscopic analysis selected from a group consisting of elongate striations, elongated cell blocks and swirling patterns; and c) a crystallographic structure detectable by X-ray diffraction selected from a group consisting of a position of a diffraction peak, a relative intensity of a diffraction peak at a particular position and a ratio between any two diffraction peaks at two particular positions.

40. A composition as claimed in claim 36, wherein the flakes of the major proportion are metallic and comprise at least two cell blocks in the planar surface of the metallic flake, any two adjacent elongated cell blocks of said at least two elongated cell blocks each have a respective longitudinal cell band orientation deviating one from the other by 30 degrees or less, a deviation of said longitudinal cell band orientations from a preferred cell band orientation normalized for each flake optionally being of 25° or less.

41. A composition as claimed in claim 40, wherein the metallic flakes having the elongated cell blocks have at least one of an appearance and a crystallographic structure preservable during annealing of the flakes, the preservable appearance and/or crystallographic structure being substantially similar before and after the annealing being one of: a) an appearance detectable by spectrophotometer or gloss meter, the detectable appearance being selected from an optical density, a gloss value and a haze value; b) a crystallographic structure detectable by microscopic analysis selected from a group consisting of elongate striations, elongated cell blocks and swirling patterns; and c) a crystallographic structure detectable by X-ray diffraction selected from a group consisting of a position of a diffraction peak, a relative intensity of a diffraction peak at a particular position and a ratio between any two diffraction peaks at two particular positions.

42. A composition as claimed in claim 36, wherein the flakes of the major proportion are metallic and have swirling patterns, the metallic flakes having at least one of an appearance and a crystallographic structure preservable during annealing of the flakes, the preservable appearance and/or crystallographic structure being substantially similar before and after the annealing being one of: a) an appearance detectable by spectrophotometer or gloss meter, the detectable appearance being selected from an optical density, a gloss value and a haze value; b) a crystallographic structure detectable by microscopic analysis selected from a group consisting of elongate striations, elongated cell blocks and swirling patterns; and c) a crystallographic structure detectable by X-ray diffraction selected from a group consisting of a position of a diffraction peak, a relative intensity of a diffraction peak at a particular position and a ratio between any two diffraction peaks at two particular positions.

43. A composition as claimed in claim 36, wherein at least the flakes of the major proportion comprising on their planar surfaces at least one of the elongate marks, the elongated cell blocks and the swirling patterns, further fulfill one or more of the following structural features:
i) the flakes have an average longest length of planar surface or an average particle size D50 of 200 μm or less, 150 μm or less, or 75 μm or less;
ii) the flakes have an average longest length of planar surface or an average particle size D50 of 50 nm or more, 250 nm or more, or 1,000 nm or more;
iii) the flakes have an average thickness of 20 μm or less, 5 μm or less, 2 μm or less, or 1 μm or less;
iv) the flakes have an average thickness of 10 nm or more, 20 nm or more, or 30 nm or more;
v) the flakes have an average aspect ratio between an average longest length of the planar surface of the flakes, or an average particle size D50, and the average thickness of the flakes of 5,000:1 or less, 1,000:1 or less, 800:1 or less, 600:1 or less, or 400:1 or less; and
vi) the flakes have an average aspect ratio between an average longest length of the planar surface of the flakes, or an average particle size D50, and the average thickness of the flakes of 3:1 or more, 5:1 or more, 10:1 or more, or 20:1 or more.

44. A composition as claimed in claim 36, wherein the flakes of the major proportion are coated with a second material different from the first material and from a native oxide thereof.

45. A composition as claimed in claim 36, wherein the first material comprises or consists of aluminium.

46. A composition as claimed in claim 36, wherein at least the flakes of the major proportion comprising on their planar surfaces at least one of the elongate marks, the elongated cell blocks and the swirling patterns, are produced by a method which comprises:
a. supporting two supply cylinders and a fatiguing rod assembly, that includes at least one fatiguing rod, in such a manner that each fatiguing rod is sandwiched between the two supply cylinders made of the first material from which flakes are to be produced, each fatiguing rod having a diameter smaller than an initial diameter of the two supply cylinders and being made of a second material harder than the first material;
b. urging the surfaces of the two supply cylinders into contact with each fatiguing rod; and
c. causing the supply cylinders and the fatiguing rods to rotate while making rolling line contact with one another;
wherein at least one fatiguing rod of the fatiguing rod assembly is textured; and
wherein the supply cylinders and each fatiguing rod are urged against one another with sufficiently high contact pressure to modify the surface of the supply cylinders by fatigue and result in separation of flakes of the first material from the surfaces of the supply cylinders.

47. A method of producing flakes, which comprises:
a. supporting two supply cylinders and a fatiguing rod assembly, that includes at least one fatiguing rod, in such a manner that each fatiguing rod is sandwiched between the two supply cylinders made of a first material from which flakes are to be produced, each fatiguing rod having a diameter smaller than an initial diameter of the two supply cylinders and being made of a second material harder than the first material;
b. urging the surfaces of the two supply cylinders into contact with each fatiguing rod; and
c. causing the supply cylinders and the fatiguing rods to rotate while making rolling line contact with one another;
wherein at least one fatiguing rod of the fatiguing rod assembly is textured; and
wherein the supply cylinders and each fatiguing rod are urged against one another with sufficiently high contact pressure to modify the surface of the supply cylinders by fatigue and result in separation of flakes of the first material from the surfaces of the supply cylinders.

48. A method as claimed in claim 47, wherein a fluid is applied to the supply cylinders and fatiguing rods, as they are rotated, the fluid being a liquid or a gas carrying away the produced flakes.

49. A method as claimed in claim 48, further comprising collecting the produced flakes and the fluid.

50. A method as claimed in claim 49, further comprising separating at least a proportion of the produced flakes from the collected fluid.

51. A method as claimed in claim 47, wherein at least one textured fatiguing rod fulfils at least one of a) having an average surface roughness (Ra) greater than 0.2 μm, greater than 1 μm, greater than 2 μm, or greater than 3 μm; and b) being coated with a layer, or with particles, of a third material different from the first and the second material.

52. A method as claimed in claim 47, wherein the texture of at least one textured fatiguing rod or a segment thereof is a) random; or b) follows a repeating pattern of continuous or interrupted protrusions.

53. A method as claimed in claim 52, wherein at least one textured fatiguing rod comprises at least one continuous protrusion or series of aligned projections fulfilling at least one of: a) having a height D of at least 3 μm, at least 50 μm, or at least 100 μm; and optionally at most 300 μm, at most 250 μm, or at most at most 200 μm; the protrusion or projections optionally having a relatively flat top surface at the apex, the top surface having a width T of at least 25 μm, at least 50 μm, at least 100 μm, or at least 200 μm; and optionally at most 500 μm, at most 400 μm, or at most 300 μm; the protrusion or projections optionally having tapering faces between the surface of the rod and the apex; b) forming an angle α with respect to the axis of rotation of the fatiguing rod, the angle between the at least one continuous protrusion or series of aligned projections and the axis of rotation being 90° or less and optionally between 0° and 60°, between 2° and 50°, or between 5° and 45°; c) a distance G between lateral edges of adjacent protrusions or adjacent projections of the at least two series is between 25 μm and 300 μm, or between 25 μm and 250 μm, or between 25 μm and 200 μm.

54. A method as claimed in claim 47, wherein the fatiguing rod assembly includes two fatiguing rods at least one of the fatiguing rods being made of the second material and the same rod, or the other, being textured, the two fatiguing rods being same or different.

55. Aluminium flakes comprising or consisting of aluminium, the aluminium flakes being produced by a method which comprises:
a. supporting two supply cylinders and a fatiguing rod assembly, that includes at least one fatiguing rod, in such a manner that each fatiguing rod is sandwiched between the two supply cylinders made of a first material comprising or consisting of aluminium from which the aluminium flakes are to be produced, each fatiguing rod having a diameter smaller than an initial diameter of the two supply cylinders and being made of a second material harder than the first material;
b. urging the surfaces of the two supply cylinders into contact with each fatiguing rod; and
c. causing the supply cylinders and the fatiguing rods to rotate while making rolling line contact with one another;
wherein at least one fatiguing rod of the fatiguing rod assembly is textured; and
wherein the supply cylinders and each fatiguing rod are urged against one another with sufficiently high contact pressure to modify the surface of the supply cylinders by fatigue and result in separation of flakes of the first material from the surfaces of the supply cylinders,
wherein the aluminium flakes have a planar surface dimension greater than an edge surface dimension and are optionally further characterized by having on at least one of their planar surfaces at least one of a following structural feature: a) at least three elongate marks; b) at least two cell blocks; and c) at least one swirling pattern.
